(19) United States
(12) Patent Application Publication
(10) Pub. No.: US 2023/0351506 A1
(43) Pub. Date: Nov. 2, 2023

(54) ENHANCED ELECTRONIC DATABASE MANAGEMENT SYSTEM WITH REDUCED DATA REDUNDANCY

(71) Applicant: ADITUM ALTERNATIVES, Rancho Santa Fe, CA (US)

(72) Inventor: Kenneth I. McGuire, Rancho Santa Fe, CA (US)

(21) Appl. No.: 18/218,747

(22) Filed: Jul. 6, 2023

Related U.S. Application Data
(63) Continuation-in-part of application No. PCT/US2022/011300, filed on Jan. 5, 2022.
(60) Provisional application No. 63/134,245, filed on Jan. 6, 2021.
(60) Provisional application No. 63/216,310, filed on Jun. 29, 2021.

(51) Int. Cl. G06Q 40/04

(52) U.S. Cl. CPC G06Q 40/04

(57) ABSTRACT

Methods, systems, and apparatus, including computer programs encoded on computer storage media, for distributed and parallel processing of data required for industry standard interfaces. A distributed processing system implements a plurality of computing subsystems including an enhanced recordkeeping subsystem and a plurality of participant subsystems. The enhanced recordkeeping subsystem maintains unit quantities for a plurality of users and provides to each participant subsystem a set of scaling factors from which multiple components of an industry standard interface can be derived by the participant systems in parallel, thereby reducing the requirements of centralized processing and network bandwidth of prior approaches.

### CROSS-REFERENCE TO RELATED APPLICATIONS

This application is a bypass continuation-in-part of, and claims priority to, International Application No. PCT/US2022/011300, filed Jan. 5, 2022, which claims the benefit of U.S. Provisional Pat. App. No. 63/134,245, filed Jan. 6, 2021, and claims the benefit of U.S. Provisional Pat. Ap. No. 63/216,310, filed Jun. 29, 2021. The entirety of the prior applications are herein incorporated by reference.

### TECHNICAL FIELD

This specification generally relates to databases, and, in one example implementation, specifically relates to an enhanced recordkeeping system that implements an improved data standardization technique.

### BACKGROUND

Data standardization is the process of bringing data into a uniform format that allows consumers of the data to analyze, process and generally utilize the data. In statistics, standardization refers to the process of putting different variables on the same scale in order to compare scores between different types of variables. A similar standardization concept, i.e., identifying and capturing the relationships among different data items in a given data set, may be applied to record keeping systems to improve their efficiency and their ability to share data across heterogeneous systems performing functionally adjacent processes. In the absence of this form of standardization, unique, customized, non-standard interfaces must be built and maintained for data to be shared across heterogeneous systems. Such interfaces are costly to develop/maintain and are often prone to error due in part to their limited application.

Conventional electronic recordkeeping systems often store dramatically more information in these databases than is necessary, wasting precious storage space, and they process this information in an inefficient manner, wasting valuable computational resources.

### SUMMARY

According to one example implementation, this specification describes an enhanced recordkeeping system that, as a result of a standardization approach that scales dependent data items, e.g., the unit holder's uncontributed commitment, to an independent data item, i.e., the holder's number of units, reduces the amount of storage that is required for each illiquid drawdown vehicle holder, that reduces the number of calculations that are required in the allocation to unit holders of illiquid drawdown vehicle gains, fees, and expenses and determinations of illiquid drawdown vehicle resource calls and returns, that generally reduces the amount of computer processing that is required to administer co-mingled vehicles which utilize resource calls (i.e., drawdown vehicles), including via distributed parallel reporting using industry standard interfaces which generally reduces the need for centralized computing resources, and that, as a result of the relationship enforced between units owned and other items reflecting a holder's vehicle interest, enables more computationally efficient transfers among holders of their vehicle interests, which could be executed using digital tokens, via functionally adjacent systems implemented using blockchain technology. These improvements can be obtained by reducing data redundancy within the data recorded to reflect each illiquid drawdown vehicle holder's ownership as well as illiquid drawdown vehicle resource calls and resource returns, via use of each holder's number of units owned as the independent data item to which other data items are scaled in various collections of data as described below.

As an approach to data standardization, in some collections of data, well defined relationships, applicable to each individual data set within the collection, can be identified as existing between items within a data set. Such relationships (e.g., scaling factors) may be stored only once for the entire collection and within each data set, only the independent or reference data item need be stored. For each data set, the data items dependent on the reference data item need not be stored, but can be derived when needed, given the associated independent data item and the standardized scaling relationship applicable across the collection of data. This approach provides the benefits of (1) reducing the storage space required for each data set and therefore for the entire collection of data, (2) reducing the amount of data required to be copied or transmitted when working with multiple data sets from the collection, (3) standardizing on the use of independent reference data item(s) by the data assembling system so that each complete data set, including dependent data items can be correctly interpreted and applied by functionally adjacent heterogeneous data consuming systems and (4) facilitating distributed parallel processing and reporting of data sets, which can be conducted given the established data standardization.

As noted above, through the use and enforcement of this data standardization approach within the described enhanced recordkeeping system in which different variables are put on a common scale, in this case a number of units, both the amount of storage required and the number of calculations required are reduced. For example, the administration of illiquid private market drawdown vehicles generally requires that a holder's equity amount and their uncontributed commitment amount be stored. By scaling these values to the holder's number of units, the scaling factors which apply to every holder are stored once and only the number of units owned must be stored for each holder. This reduces the storage locations required by number of holders less three (needed to store the vehicle's units and the scaling factors). FIG. 1A1 illustrates vehicle and holder data structures for both the unscaled and scaled, i.e., unitized examples given. Similarly, the administration of illiquid private market drawdown vehicles generally requires gains, fees and other items to be allocated to each holder with a division and a multiplication of the form:

Holder allocation=holder equity/vehicle equity×vehicle quantity to be allocated. (1)

By scaling both the vehicle quantity and each holder's equity to their number of units owned, a holder allocation is a single division:

allocation per unit=vehicle quantity to be allocated/number of vehicle units (2)

and one multiplication per holder:

holder allocation=allocation per unit×holder's number of units (3)

A similar dynamic applies with regard to allocating resource call amounts. The administration of illiquid private market drawdown vehicles generally requires resource call amounts to be allocated to each holder with a division and a multiplication of the form:

holder resource call amount=holder uncontributed commitment/vehicle uncontributed commitment×vehicle resource call amount (4)

By scaling the resource call amount to the number of vehicle units, the resource call allocation is a single division:

resource call per unit=vehicle resource call amount/number of vehicle units, (5)

and one multiplication per holder:

holder resource call allocation=resource call per unit×holder's number of units (6)

When applied to these allocations, this standardized scaling reduces the number of divisions required by the number of holders less one (needed to calculate the allocation per unit). Additionally, these holder resource call allocations can be calculated on a distributed parallel basis by multiple systems each positioned closer to a subset of holders, reducing the need for and consumption of centralized computing resources.

The vast majority of co-mingled investment vehicles available to the public, such as mutual funds and exchange traded funds (ETFs) are administered and reported on the basis of units. For a given vehicle, each holder's broker or advisor maintains the number of units owned by the holder. The vehicle's administrator scales the Net Asset Value (NAV) of the vehicle according to the number of vehicle units and publishes the vehicle's unit NAV using industry standard interfaces, allowing the holder's broker or advisor to independently calculate and report the value of the holder's interest in the vehicle. Co-mingled investment vehicles which invest in illiquid assets have typically been operated as drawdown vehicles and administered as limited partnerships, with each limited partner having their own multi-component holder account, instead of being issued units. Individual holder accounts are used in this circumstance in part to capture and track the uncontributed commitment associated with each holder. When applied in the broader context of retail holders, the individual holder account approach is non-standard and requires that unique, customized interfaces be developed in the functionally adjacent reporting systems of brokers and financial advisors in order for the value of such investment holdings to be reported to their respective client holders.

To report retail holdings in comingled vehicles that use individual multi-component holder accounts and are therefore not unitized (i.e., not scaled to the number of units), financial intermediaries such as Fidelity, Goldman Sachs and others have developed and employed customized interfaces. Within these customized interfaces, the reporting firm often assigns a fictional unit NAV of $1 to the investment vehicle and a fictional quantity of units to each holder. These fictional amounts are such that when the (fictional) quantity of units is multiplied by the (fictional) unit NAV within the core reporting system, in the industry standard calculation, the correct value of the individual's holding is derived. In subsequent data transfers provided to reporting firms in order for them to issue revised valuation reports to holders, the customized, non-standard interface inserts a fictional increase or decrease in the quantity of units in order to create the revised valuation. These fictionalized increases and decreases are reported to the holder as “units added” or “units removed”, which is misinformation since these vehicles employ individual holder accounts and don't issue units at all. These non-standard interfaces therefore result in inaccurate holder reporting, ineffective customer service and on-going holder confusion. The enhanced recordkeeping system described by this specification, by using each holder's number of units as the independent data item to which other data items are scaled in various data collections, avoids the need for individual multi-component holder accounts and the associated customized, non-standard interfaces to functionally adjacent reporting systems and enables reporting of valuations and other metrics in an industry standard form, scaled to the number of units. The standardization and efficiencies provided by this implementation are intended to make co-mingled investment vehicles that invest in illiquid assets available to a larger population of holders, which will in turn benefit all holders with greater economies of scale.

Another example implementation includes a computer-implemented method for enhanced recordkeeping of co-mingled private market investment vehicles over at least one network. The method includes storing data and instructions in at least one computer memory and accessing the stored instructions and executing the stored instructions with at least one computer processor to perform multiple operations. The method also includes operations for processing and recording subscriptions in the form of uncontributed commitments, converting accepted subscribers to holders by issuing units, as well as processing and recording redemptions which may consist in part of non-cash, cash equivalent proceeds. The method includes operations for issuing, tracking and processing resource calls, and returning previously called resource, possibly with distributions of gains, to unit holders. The method also includes operations for tracking and processing vehicle accounting data including portfolio holdings and related resource actions, portfolio valuations and financial balances in order to monitor a vehicle's underlying uncontributed commitments, determine whether appropriate to call resource from unitholders or distribute previously contributed resource to unitholders and measure the vehicle's portfolio diversification. The method includes electronic interactions with other systems used in the administration of unitized collective investment vehicles, including Vehicle Accounting and Transfer Agency systems. The method further includes sending electronic notifications to and receiving electronic notifications from subscribing participant systems over the network, including notifications related to subscriptions, redemptions, resource calls and resource returns.

Assets other than cash, i.e., cash equivalents, may sometimes be used as cash. These assets generally have a stable value relative to the cash currency in which they are denominated. Money market fund units and U.S. treasury bills are long standing examples. More recently, tokenized digital currencies have developed that have a stable relationship to the U.S. dollar. These “stablecoins” are becoming currencies of choice for transactions on blockchain systems. For example, USDT (also known as Tether) and USDC stablecoins had collective values of more than $70B and $31 billion respectively, as of September 2021. The potential to use these and/or other cash equivalent assets as a medium of transaction wholly or partially in place of cash, in each case with a quantity of tokens, bills, etc. of equivalent value to the cash replaced, is to be assumed in the processes documented herein.

This example implementation reduces data redundancy within the data recorded to reflect each illiquid drawdown vehicle holder's ownership by recognizing and maintaining a well-defined relationship between the number of units held by each holder and the holder's uncontributed commitment (UHC). This well-defined relationship is encapsulated in an uncontributed commitment per unit (unit UHC). On the basis of this relationship, each individual holder's uncontributed commitment need not be stored or transmitted to other systems which consume the vehicle's holder data. In addition, reporting of each holder's uncontributed commitment can be performed on a distributed parallel basis, reducing the amount of centralized computing resource required, and consistent with the industry standard per unit approach used to report other metrics, by multiple systems each positioned closer to a subset of holders. Similarly, this implementation reduces data redundancy within the data recorded to reflect the vehicle's resource calls and resource returns by recognizing and maintaining a well-defined relationship between the number of units held by each holder and the holder's resource call and resource return amounts. These well-defined relationships are encapsulated respectively in a unit resource call amount and a unit resource return amount. As a result, each individual holder's resource call and resource return amounts need not be stored for any resource call or resource return, nor transmitted to systems that participate in the resource call or resource return processes. In addition, reporting of resource calls and resource returns can be performed on a distributed, parallel, industry standard per unit basis, by multiple systems each positioned closer to a subset of holders, thereby reducing the amount of centralized computing resource required. Finally, by scaling these relationships to a single unit, i.e., “unitizing”, the implementation makes units interchangeable. This fungibility is a requisite characteristic of digital tokens, such as those maintained via blockchain technology. Thus, units administered by this implementation along with other related items reflecting a holder's vehicle interest, such as the holder's uncontributed commitment, could be reflected in a digital token, where each token might reflect a quantity or portion of a unit interest, and transferred among holders by functionally adjacent, blockchain based systems.

Other implementations of this aspect include corresponding systems, apparatus, and computer programs recorded on computer storage devices, each configured to perform the operations of the methods.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A1 illustrates unsealed and scaled examples of vehicle and holder data structures.

FIG. 1A2 is a block diagram illustrating an operating environment for a system for administering a co-mingled illiquid private market drawdown vehicle in accordance with an implementation.

FIG. 1B is a version of FIG. 1A2 annotated with industry standard data flows in conjunction with a common form of vehicle which does not require an enhanced recordkeeping system.

FIG. 1C is a version of FIG. 1B annotated with enhanced recordkeeping system data flows that standardize data flows in conjunction with an illiquid drawdown vehicle.

FIG. 1D is a block diagram illustrating a basic structure of an illiquid drawdown vehicle in accordance with another implementation.

FIG. 1E is a block diagram illustrating a basic structure of an illiquid drawdown vehicle in accordance with another implementation.

FIG. 2 is a block diagram illustrating components of an enhanced recordkeeping system in accordance with another implementation.

FIG. 2A provides a partial list of database entities employed by an example implementation of an enhanced recordkeeping system.

FIG. 3 is a block diagram illustrating further components of an enhanced recordkeeping system in accordance with another implementation.

FIG. 4 is a flow chart illustrating a method by which the enhanced recordkeeping system processes vehicle accounting data in accordance with another implementation.

FIG. 5 is a flow chart illustrating a method by which the enhanced recordkeeping system processes transfer agent data in accordance with another implementation.

FIG. 6 is a flow chart illustrating a method performed by the enhanced recordkeeping system to validate subscriptions in accordance with another implementation.

FIG. 7, FIG. 7A and FIG. 7B are flow charts illustrating a method performed by the enhanced recordkeeping system to execute valid subscriptions in accordance with another implementation.

FIG. 8 is a flow chart illustrating a resource call method performed by the enhanced recordkeeping system in accordance with another implementation.

FIG. 9 is a flow chart illustrating a method performed by the enhanced recordkeeping system to track holder receivable responses in accordance with another implementation.

FIG. 10 is a flow chart illustrating a resource return method performed by the enhanced recordkeeping system in accordance with another implementation.

FIG. 11 is a flow chart illustrating a method to validate redemptions (unit repurchases in some implementations) by the enhanced recordkeeping system in accordance with another implementation.

FIG. 12, FIG. 12A, FIG. 12B and FIG. 12C are flow charts illustrating a method to execute redemptions (unit repurchases in some implementations) by the enhanced recordkeeping system in accordance with another implementation.

FIG. 13 is a flow chart illustrating a method to merge two commitment vintages. Commitment vintages are a mechanism of the invention designed to limit dilution by newly subscribed holders of existing holder interests.

### DETAILED DESCRIPTION

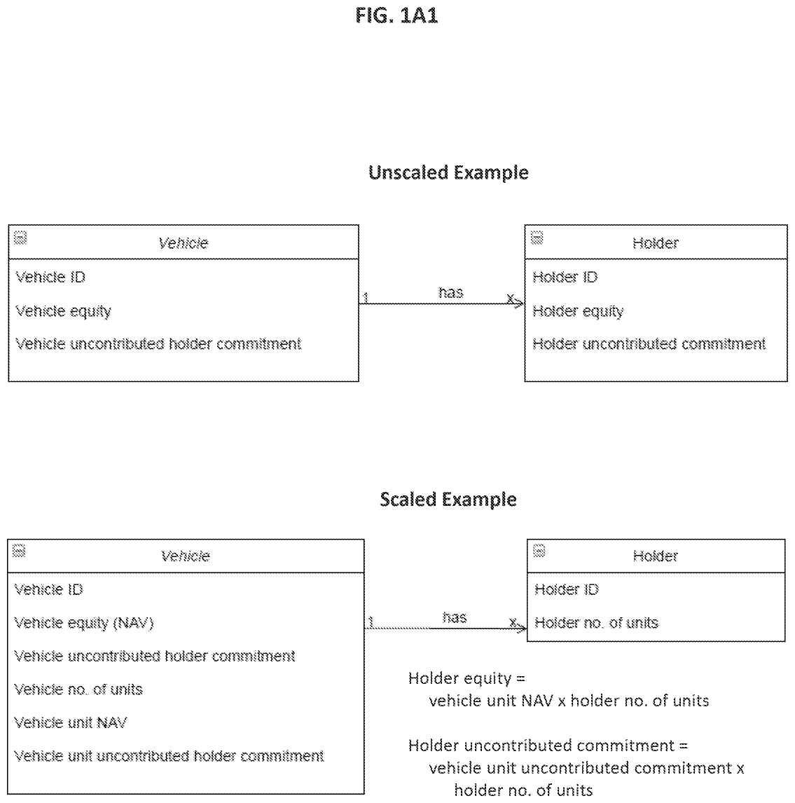

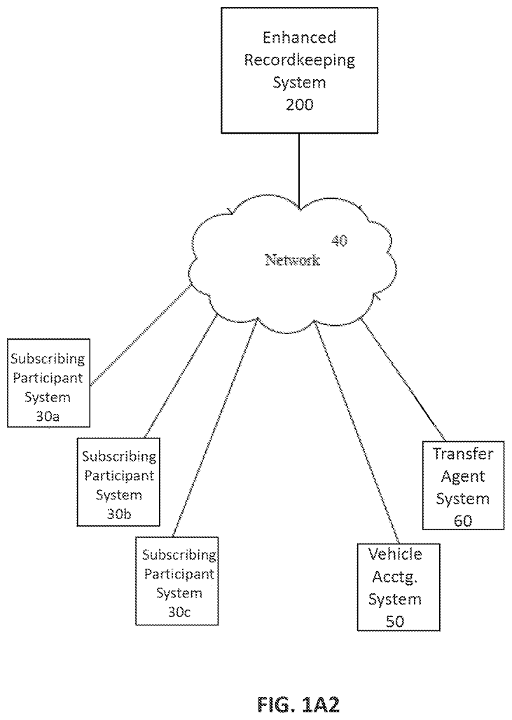

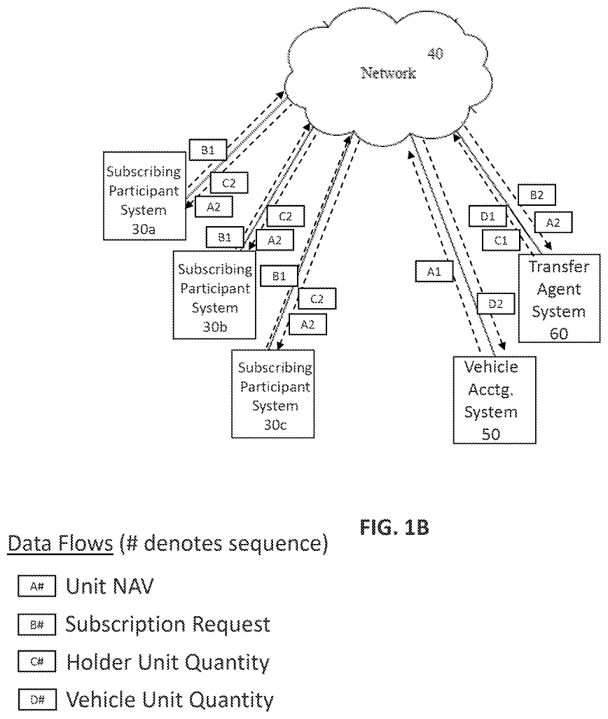

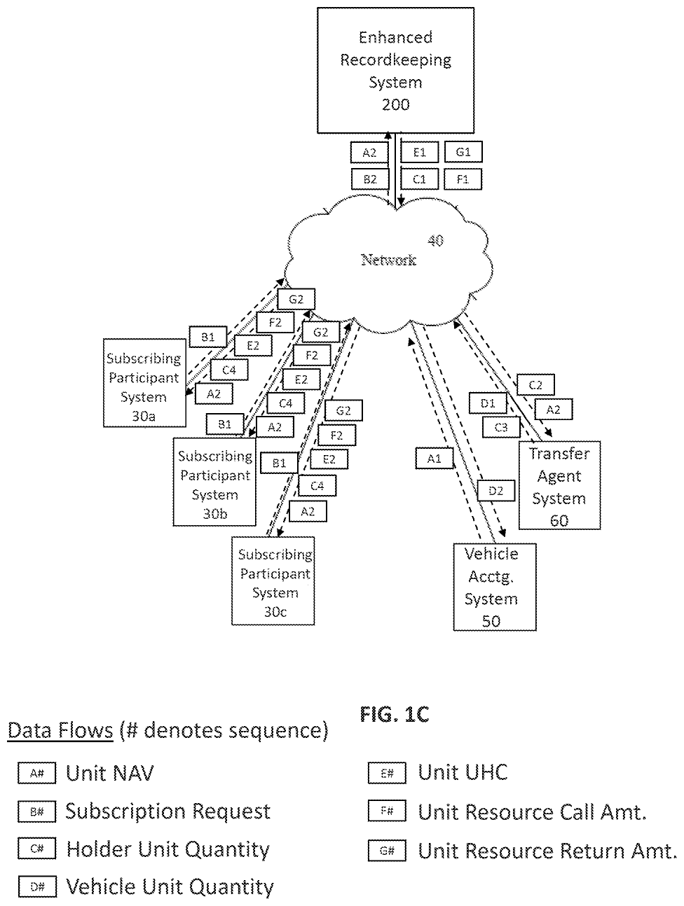

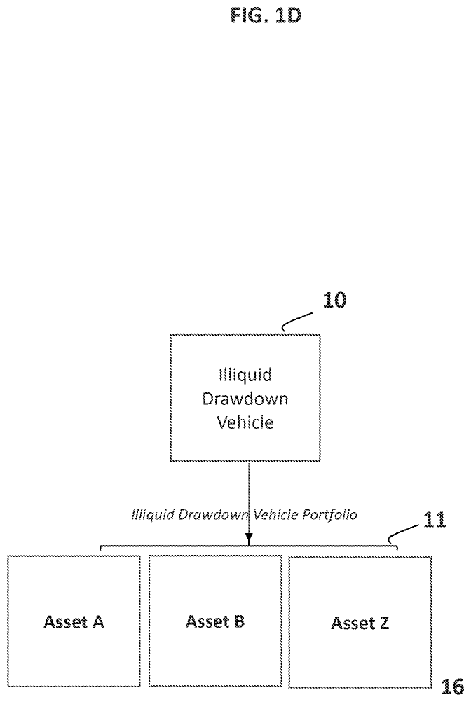

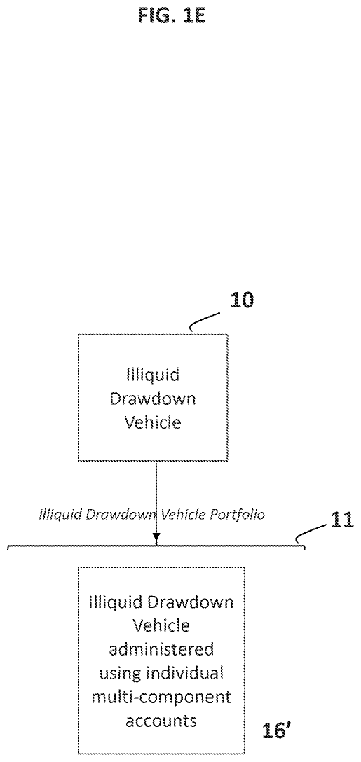

FIG. 1A2 is a block diagram illustrating an operating environment for an example system for enhanced record keeping with reduced redundancy. An enhanced recordkeeping system 200 may be connected over a network 40 with subscribing participant systems 30a-c. A vehicle accounting system 50 and a transfer agent system 60 may also be connected. Additional systems that are not shown may also be connected. Further, a larger or smaller number of the illustrated systems may be included.

A collective investment vehicle is a structure through which assets contributed from multiple (whether a handful or tens of thousands) individuals and institutions are blended together into a single vehicle which invests in underlying assets. Mutual funds are the most common collective investment vehicle. FIG. 1B identifies standard data flows as may be used in conjunction with common vehicles, such as mutual funds. As noted on FIG. 1B, data flows may be comprised of subscription requests, unit data, including unit NAV value, vehicle unit quantity and specific vehicle holder unit quantity which in the configuration of FIG. 1B, used in conjunction with a common form of vehicle which does not require an enhanced recordkeeping system, is calculated by the transfer agent system 60 and disseminated on the network 40 via data flow C1. Standard data flows are scaled to units to enable efficient and reliable communications among cooperative systems in support of the vehicle and its subscribers who become holders.

Mutual funds have an indefinite life and are therefore considered to be “evergreen”. Mutual fund holders contribute all their at-risk resource at the time of their investment. Unlike mutual funds, given the extended identification and due diligence processes for private market assets, as well as their illiquid nature and the complexity associated with purchasing such assets, holders of collective investment vehicles focused on private markets (i.e., private market vehicles) typically invest by making resource commitments at the time of subscription. The committed resource is not contributed at the time of subscription but is available to be drawn down by the investment vehicle (i.e., a drawdown fund) over a defined future investment period during which the vehicle may call the committed resource as needed in increments, on a pro rata basis across vehicle holders. These defined, limited investment periods are known as vintages, and are typically categorized according to the date on which resource is first deployed by the vehicle into an underlying investment.

As shown in FIG. 1C, the enhanced record keeping system 200 may be used in conjunction with illiquid drawdown vehicles to standardize data and data flows. The enhanced record keeping system introduces standardization by scaling data items, such as a holder's resource commitment to their quantity of units. The enhanced recordkeeping system serves as the source of such data, e.g., data flow C1 in FIG. 1C to the transfer agent system. The transfer agent system 60 may then propagate that data to other systems in the network 40, as is the standard dissemination methodology used in conjunction with co-mingled vehicles. The enhanced recordkeeping system 200 combines the unit NAV from the vehicle accounting system, data flow A2 in FIG. 1C, with a commitment amount specified in a subscription request, data flow B2 in FIG. 1C, and the unit UHC which it maintains, to calculate each holder's quantity of units and subsequently informs the transfer agent system 60, via data flow C1 in FIG. 1C.

During a first time period T1, the vehicle accounting system 50 transmits the unit NAV A1 to the enhanced recordkeeping system 200. And a subscribing participant system, e.g., the subscribing participant system 30a, transmits a subscription request B1 having a subscription amount to the enhanced recordkeeping system 200. Per typical industry practice, this subscription amount is contributed at the time of subscription. In the context of an illiquid drawdown fund, this subscription amount represents a commitment to make future contributions. Because the subscribing participant systems 30a-c, the vehicle accounting system 50, and the transfer agent system 60 may all store information and or/communicate using formats that are non-standardized with respect to each other, during a second time period T2, the enhanced recordkeeping system standardizes this data by computing the holder's quantity of units using the unit NAV and the commitment amount, so as to store, analyze and communicate, e.g., in real time or near real time, the data in a standard format, regardless of the format in which the data was received.

During a third time period T3, the enhanced recordkeeping system 200 provides the standardized quantity, i.e., in a standardized format, of holder units C3 to the transfer agent system 60.

During a fourth time period T4, the transfer agent system 60 disseminates the quantity of holder units C4 on the network 40, via data flow C3 in FIG. 1C. By combining these data items in its calculation of units, the enhanced recordkeeping system maintains a standardized, scaled relationship between the number of units and every holder's portion of both NAV and UHC, reflected in the unit NAV and unit UHC respectively. Additionally, the enhanced record keeping system 200 can provide other critical data (data flows E1, F1, and G1) in a standardized, unit-scaled format to data consuming systems, such as subscribing participant systems 30, in the network 40, consistent with other data flows typically received by such systems (e.g., data flow A2, unit NAV). In the absence of the enhanced recordkeeping system 200, administration of illiquid drawdown vehicles requires the use of non-standard approaches and interfaces. As noted previously, such non-standard interfaces may cause attempts at calculation to fail completely, they are inefficient, e.g., they require the consumption of significant additional computational resources to generate the same results, they introduce fictitious data, and they result in inaccurate holder reporting, ineffective customer service and on-going holder confusion.

As noted above, vintage drawdown vehicles are the form of collective investment vehicle typically used by institutions and high net worth individuals to access private markets. Vintage drawdown vehicles have limited, largely sequential, phases or periods for (a) raising resource commitments, (b) investment, and (c) harvesting (e.g., return of resource, gains, income, etc.). Typically, vintage drawdown vehicles call resource from holders only to apply it to private market assets or to pay imminent expenses. Similarly, vintage drawdown vehicles typically return resource to holders when the resource is released from underlying assets. Thus, vintage drawdown vehicle holders' exposure to private market assets varies significantly over the life of the investment vehicle, starting and ending with zero exposure.

In contrast to vintage vehicles, evergreen vehicles engage in continuous, simultaneous financial resource raising, investment and harvesting. The advisor of a private market evergreen vehicle makes multiple underlying private market investments on an on-going basis, managing their diverse cycles of resource use and return. This approach better reflects the wide diversity in the investment horizons of individual holders by maintaining a relatively consistent and high exposure to private market assets. The evergreen vehicle advisor, on behalf of all evergreen vehicle holders, is responsible for blending multiple underlying vintages in order to maintain a relatively consistent and high portion of vehicle resource employed in the private markets.

Vintage vehicle holders maintain control of their assets when not employed in private markets and as such can maintain their resource efficiency by applying those assets to a liquid investment or to another short-term purpose of their choice. Per current practice, design, and implementation, the full at-risk resource of an investment in an evergreen vehicle is contributed by the holder at the time of unit purchase/subscription. The current form of evergreen vehicle cannot call for additional resource from its holders. As a consequence, given the episodic availability of private market assets, an evergreen vehicle that raises significant new assets, which are not immediately applied to private market investments, significantly dilutes the private market interests of their prior holders. For example, an evergreen private market vehicle that doubles its assets, effectively halves the private market exposure of prior holders until such time as the new assets can be applied to the private markets. Also, due to the unpredictable availability of underlying private market assets, private market focused evergreen vehicles may maintain a significant portion of liquid assets in order to take advantage of private market investment opportunities when available and meet the potential associated resource needs of its private market assets. While liquid assets can take many forms, most private market focused evergreen vehicles have generally avoided investing in forms other than cash and cash equivalents to avoid incurring investment risk other than that associated with the private market investment strategy to which the holder subscribed. These significant balances of cash and cash equivalents dampen the return generated by private market investments, reducing their benefit and creating “cash drag.” Alternatively, evergreen vehicles whose liquid assets are inadequate to meet their resource commitments may face significant penalties for default on unmet resource commitments.

Collective investment vehicles are needed which combine the resource cycle management features of evergreen vehicles and the resource efficiency of vintage vehicles. These collective investment vehicles would: a) facilitate the flow of assets from liquid to illiquid, i.e., employed in private markets, and back, reflecting the changing levels of resource use by the illiquid private market portfolio, b) provide a method to limit dilution and c) have a variable life-span operating over the course of a single vintage, multiple vintages or indefinitely, as an evergreen vehicle does. While existing systems could be used to administer such collective investment vehicles, existing systems were not designed and developed to support these features. The enhanced recordkeeping system described by this specification enables the administration of such collective investment vehicles in a manner that is more efficient than available via current systems. For instance, the enhanced recordkeeping system described by this specification allows calculations to be performed, or allows calculations to be performed using fewer computing resources, by placing and maintaining data in a standardized format, regardless of the format that the data was supplied by constituent systems.

Legacy systems used in the administration of vintage vehicles maintain individual multi-component accounts for each subscribing partner, with each account containing the holder's amounts of resource committed, resource contributed, and resource not yet contributed (i.e., the holder's uncontributed resource commitment). Maintaining holder accounts in this way enables the vintage vehicle practice of uncontributed resource commitments while also providing for individualized holder treatment (e.g., individually tailored advisory fee calculations). Within the context of a typical vintage vehicle, where the number of holders is no more than a few hundred, the desire for the flexibility to individually tailor a holder's treatment outweighs the associated complexity in operation and reporting. Within legacy vintage vehicle administration systems, resource calculations (including resource calls and returns), allocation of vehicle gains, fees and other expenses are performed individually for each holder. Furthermore, all holder reporting is centrally produced (since each holder can receive individualized treatment) and transfers of vehicle ownership interests among holders are complex (since each holder's ownership interest may have unique characteristics).

In contrast, evergreen vehicles are intended to support tens of thousands or more holders. As such, individualized holder treatment would be extremely inefficient as well as operationally unwieldy for evergreen vehicles to administer. Instead, evergreen vehicles fashion their treatment of holders around a single unit and a holder's treatment is based on the number of units they own. This approach allows evergreen vehicles to be administered using systems which segregate processing that is specific to individual holders from processing that impacts the holders collectively. The individual holder processing is generally housed in a Transfer Agent system, while the collective vehicle processing is housed in a Vehicle Accounting system. Processing that impacts an individual evergreen vehicle holder's units is the purview of a Transfer Agent system. Processing that impacts every evergreen vehicle unit (or at least every unit within a pre-defined class of units) is the purview of a Vehicle Accounting system. Such processing includes allocations of vehicle gains, fees, and expenses. Under this approach, the value of each holder's interest in the vehicle is equal to the vehicle's (or vehicle unit class's) unit NAV multiplied by the individual holder's number of units. Neither current Vehicle Accounting nor current Transfer Agent systems address a holder's uncontributed resource commitment, which is a critical feature addressed by the system described herein to facilitate the flow of assets from liquid to illiquid and vice-versa and provide a means to limit dilution within the needed collective investment vehicles.

The enhanced recordkeeping system described by this specification occupies a functional space between current Vehicle Accounting and Transfer Agent systems. When employed, the enhanced recordkeeping system enables the efficient administration of an illiquid drawdown vehicle 10 with holdings comprised of illiquid private market assets 16. The enhanced recordkeeping system is employed in processing subscriptions to and redemptions from this form of unitized collective investment vehicle, as well as reporting on the implications of a variety of such vehicle's other activities. Also, the enhanced recordkeeping system enforces standardization, e.g., by applying unitization (i.e., scaling to a number of units) to each resource transaction that occurs when liquid assets are called by the drawdown vehicle to support the illiquid private market portfolio, and when liquid assets are returned from the drawdown vehicle. Such an approach may change data from a non-standardized format, in which each holder's individual resource call and resource return amounts must be specified and communicated, to a standardized format which is capable of more efficient processing, in which unitized resource call and return amounts apply uniformly to the population of holders and their individual amounts may be determined by distributed systems according to each holder's number of units.

In particular, the enhanced recordkeeping system 200 introduces an unconventional distributed architecture. The unconventional distributed architecture is nevertheless compatible with industry standard interfaces that typically require multiple fields to be reported to users. As one example, reporting systems for vehicles that maintain uncontributed commitment amounts have interfaces that generally require reporting at least a net asset value amount as well as an uncontributed commitment amount. Having an enhanced recordkeeping system that is compatible with these industry standard interfaces removes the need to develop customized interfaces as described above.

But the system need not maintain data for these industry standard interfaces. Instead, the system can store a single value for each user from which other components of the standard interfaces can be derived by a collection of scaling factors. In other words, a single value stored by the can be used to derive all the data for the industry standard interfaces.

Essentially, the enhanced recordkeeping system 200 intermediates between the vehicle accounting system 50 and the transfer agent system 60, allowing these systems to perform their industry standard functions. Any updates to unitized values, e.g., unit NAV and unit UHC, are made at the enhanced recordkeeping system 200 for all users as a whole. This greatly simplifies and speeds up the processing that is required for maintaining large numbers of accounts. For example, if there are ten million holder accounts associated with single vehicle, the enhanced recordkeeping system 200 needs to compute only a handful of new unitized values, e.g., new values for unit NAV and unit UHC.

In prior systems, all components of the industry standard interfaces have to be recomputed, which would require computing and storing at least 20 million values for 10 million holder accounts. Moreover, the 20 million values would then all need to be sent over the network 40 to the participant systems 30a-c.

For example, in the case of a resource return event, the quantities of units for the individual holders do not change. Rather, the enhanced recordkeeping system can simply recompute a unit UHC value. Therefore, for 20 million users the record-keeping requirements have been reduced from 20 million computations to 1 single computation.

In general, the system only needs to compute, store, and send the quantities of units to the participant systems 30a-c. The participant systems 30a-c can then compute in parallel and in a distributed fashion the multiple elements of data that are required for the industry standard interfaces using the scaling factors. As one example, from N quantities of units received, each participant subsystem can compute 2N values for the industry standard interfaces. In addition to being faster and requiring fewer resources, this is also advantageous because the participant systems can perform specialized processing for their individual users. Therefore, the unconventional architecture as illustrated minimizes the network impact by sending less data over the network and by processing data close to its intended recipients.

In this specification, the participant systems performing processing in parallel means that the systems are free to perform the required computations without any dependency on any other system and that at least some of the computations performed by different systems are performed during at least partially overlapping time windows.

In more detail, the enhanced recordkeeping system can confer several computational and network advantages over prior systems whenever there is an update to the quantities of units. The quantities of units can be updated due to a number of different events, including receipt of new fund accounting data, resource call events, and resource return events, to name just a few examples.

When these events happen, the enhanced recordkeeping system 200 can perform one simplified update to the unitized values. The calculations that are required for these updates vary according to the event type and are described in more detail below. Performing this unitized value update provides vast computational advantages over prior systems that instead need to perform individualized processing to compute multiple values for every single holder according to that holder's individual circumstances.

By performing the unitized value update, the enhanced recordkeeping system obtains the appropriate scaling factors in order to have all information that is required for the industry standard interfaces. In particular, the enhanced recordkeeping system 200 can compute a unit NAV value, which may also be referred to as a unit net asset value scaling factor; and a unit UHC value, which may also be referred to as a unit uncontributed holder commitment scaling factor.

The enhanced recordkeeping system 200 can then provide the updated unitized values, which serve as the scaling factors, to all of the participant systems. Then, for each holder the enhanced recordkeeping system 200 only needs to provide one value, which is the holder's unit quantity.

The participant systems receive the scaling factors and the unit quantities and then derive all the components of the industry standard interfaces from the unitized values and each holder's unit quantity. These computations can be performed in parallel by the participant systems, which removes the need for centralized processing for this data.

And for updates that do not change the quantities of units, e.g., a resource return event, the participant systems can used previously stored quantities of units for each holder. Therefore, the enhanced recordkeeping system need only send a single updated scaling factor to each of the participant systems, which can then recompute the multiple components of the industry standard interfaces in parallel.

As a result, the unconventional distributed architecture as illustrated in FIG. 1C provides improvements in storage, computation, network bandwidth, and system compatibility that are technological advantages over prior approaches.

Additionally, the transactional and reporting capabilities offered to holders in unitized form through the system are consistent with the longstanding industry standard approach for co-mingled vehicles and provide an electronically accessible platform for accessing private market assets, thereby facilitating investment from a significantly expanded population.

As noted previously, the enhanced recordkeeping system is intended for use in administering commingled investment vehicles which a) facilitate the flow of assets from liquid to illiquid and back, b) provide a method to limit dilution and c) have a variable life-span operating over the course of a single vintage, multiple vintages or indefinitely. Use of the system in this context provides significant efficiencies over current systems, including those numbered i), ii), iii), iv), v), vi), vii), viii) and ix) below, by eliminating redundant data within several collections of data, including holder data, resource call data and resource return data. Current systems used to administer co-mingled private market, illiquid drawdown vehicles require storage of individual accounts for each holder which contain the holder's amounts of resource committed, resource contributed, resource not yet contributed and other unique, differentiating holder data. The enhanced recordkeeping system described herein, by enforcing a well-defined relationship between the number of units held by each holder in an illiquid drawdown vehicle 10 and the holder's UHC, i) eliminates the need to store each illiquid drawdown vehicle holder's uncontributed commitment, and makes illiquid drawdown vehicle units interchangeable, which in turn ii) eliminates the calculations required to the allocate illiquid drawdown vehicle 10 gains, fees and expenses to holders individually, as current systems used to administer co-mingled private market drawdown vehicles require. This is because the Vehicle Accounting system 50 allocates those items to the entire collection of units at once. Additionally, the interchangeability of illiquid drawdown vehicle units iii) enables simplified, more efficient transfers among holders of fungible units, which could be executed using digital securities via functionally adjacent systems implemented using blockchain technology. Such efficient transfers are not possible when individual ownership interests are stored with unique, non-standard, differentiating data as per current systems used to administer co-mingled private market drawdown vehicles. Similarly, by establishing, in a unit resource call amount, a defined scaled relationship between the number of units owned by a holder and their resource call amount, the system iv) eliminates the calculations required by current systems to individually allocate a holder's resource call amount based on the vehicle resource call amount, the vehicle uncontributed commitment and the holder's specific uncontributed commitment and v) eliminates the need to store and transmit each holder's resource call amount associated with each resource call, freeing precious computer memory resources. Likewise, by establishing, in a unit resource return amount, a defined scaled relationship between the number of units owned by a holder and their resource return amount, the system vi) eliminates the calculations required by current systems to individually allocate a holder's resource return amount based on the vehicle resource return amount, the total vehicle equity value and the holder's specific equity value and vii) eliminates the need to store and transmit each holder's resource return amount associated with each resource return, freeing computer resources such as disk and computer memory space for other uses.

Taken in aggregate, by eliminating redundant data within several collections of data, including holder data, resource call data and resource return data, the system viii) facilitates illiquid drawdown vehicle 10 reporting on an industry standard basis and ix) allows holder reporting to be performed on a parallel, distributed basis by adjacent systems (such as those employed by retail brokers and financial advisors) positioned more closely to holders, thereby reducing the amount of centralized computing resources needed. These adjacent systems need only to have the holder's number of units (the independent data item) and the applicable unit UHC, unit resource call amount or unit resource return amount (the defined relationship), in order to report a holder's uncontributed commitment, resource call amount or resource return amount (dependent data items), respectively.

In order to provide a means to limit dilution, the enhanced recordkeeping system may include the ability to designate illiquid drawdown vehicle subscriptions as part of a “commitment vintage”, with a different unit UHC than other commitment vintages. A commitment vintage with a higher unit UHC will result in fewer units being issued at the time of drawdown vehicle subscription and therefore contribute relatively less diluting resource when the subscription is accepted and relatively more resource subsequently when resource is called by the illiquid drawdown vehicle for investment and other purposes. As such, when commitment vintages are in use, drawdown vehicle units will be associated with a given commitment vintage, interchangeable only within that vintage, and each commitment vintage will have its own unit UHC, scaled to the number of units associated with the commitment vintage to reflect the uncontributed holder commitment of the commitment vintage. Additionally, to enforce this form of standardization, when a drawdown vehicle with multiple commitment vintages issues a resource call, each commitment vintage will have its own unit resource call amount, scaled according to the number of units associated with the commitment vintage. However, over time as resource is called and the unit UHC of given vintages approaches parity, the vehicle may collapse two vintages into a single vintage in order to simplify operations and increase fungibility of units.

Additionally, redemptions are extremely rare among vintage vehicles, due to both the limited life of vintage vehicles and the impact of relieving a holder of their uncontributed commitment, and therefore have no specific functional support available within current administration systems. Given that redemptions are desirable a feature of the needed commingled investment vehicles, which may be operated over multiple vintages, the system incorporates a redemption process not offered by current systems.

Implementations of the present system are directed to a system and method for use in administering private market illiquid investments. The system includes an enhanced recordkeeping system that facilitates and records the expected flow of assets from liquid to illiquid form and back on an on-going basis. The example implementation described herein refers to the administration of an illiquid drawdown vehicle with a single class of units, with all units having a common unit NAV. The system may be applied to vehicles with multiple classes of units either by extending the commitment vintage functionality of the example implementation to accommodate each commitment vintage having a unique unit NAV, or by applying the system on a class-by-class basis and treating each class as a sub-vehicle. In recognition that each sub-vehicle would contain only a portion of a multi-class vehicle, the latter approach would require modifications to select processes within the example implementation, including the calculation of the vehicle resource call amount, the vehicle accounting data receiver 248, the transfer agent data receiver 250, and the redemption engine 258. The former approach would allow a multi-class vehicle to be administered in its entirety at one time but would require new units to be issued with every resource call. Thus, there are practical reasons why one approach may be preferable to the other, based on the circumstances. No matter the approach, multi-class vehicle interests are relatively less fungible than single class vehicle interests. Therefore, the example implementation was described to reflect an illiquid drawdown vehicle with a single class of units having a common unit NAV.

“Illiquid,” in the context of the system, refers to the state of a security or other asset that cannot easily be sold or exchanged for cash without a material or non-trivial loss in value. Examples of illiquid assets include real estate, vehicles, private company interests, some types of debt instruments, and collectibles. On the other end of the spectrum, most listed securities traded at major exchanges, such as stocks, ETFs, mutual funds, bonds, and listed commodities, are liquid and can be sold almost instantaneously during regular market hours at fair market price. Additionally, precious metals, such as gold and silver, may be liquid. The unitized collective investment vehicles administered via the system are generally described as investing in illiquid assets in the form of private company interests but could include other types of illiquid assets.

Referring back to FIG. 1A2, and in more detail, the network 40 may include a wired or wireless local area network (LAN) and a wide area network (WAN), wireless personal area network (PAN) and other types of networks. Although only one network 40 is shown, multiple networks may function within the displayed environment so as to connect different systems over different networks. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired (including fiber optic transmission) or wireless paths. Although only one network is shown for simplicity, many networks may be included in order to connect system resources with one another and with external resources.

Subscribing participant systems 30a-30c may include any of a variety of computing systems having processors, memories and other computing components. The systems may be desktop systems, laptop systems, or mobile systems and may host a variety of applications, including network browsers and/or mobile applications for cooperation within the displayed environment. The subscribing participant systems 30a-30c may interact with the enhanced recordkeeping system 200. While a limited number of subscribing participant systems 30a, 30b, and 30c are shown, implementations of the system include many more participant systems, such as hundreds of thousands of systems connected over the network 40. The subscribing participant systems 30a-30c may store and share data in a non-standardized form with respect to each other and/or the enhanced recordkeeping system 50

Similarly, vehicle accounting systems 50 and transfer agent systems 60 may also be connected and may include computing devices configured to interact with the enhanced recordkeeping system 200. Like the subscribing participant systems 30a-30c, the vehicle accounting systems 50 and the transfer agent systems 60 may store and share data in a non-standardized form with respect to each other and/or the enhanced recordkeeping system 50.

The enhanced recordkeeping system 200 may include various types of computing systems and applications stored in an integral, connected, or remote memory structure. The enhanced recordkeeping system 200 may be included in a host system or platform at a larger firm or institution. Accordingly, the host system may include many systems and components that are not shown. The enhanced recordkeeping system 200 may be or include a computing device such as a personal computer, a laptop, a mainframe computer, a server, a workstation, or any other suitable computing device, including a collection of network connected computing devices, each with a processor, memory and software components, collectively operating to perform the administrative processes for the administered vehicles.

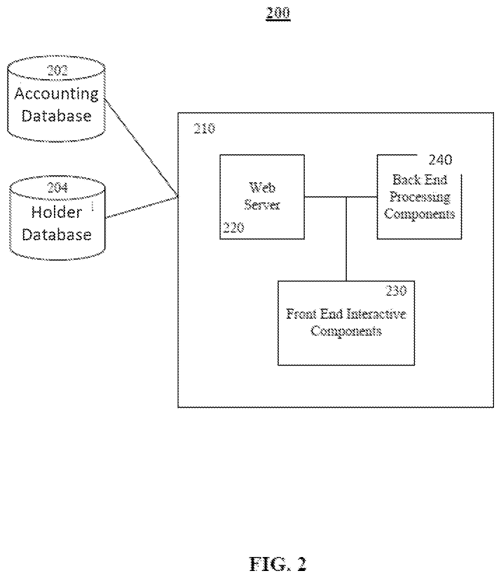

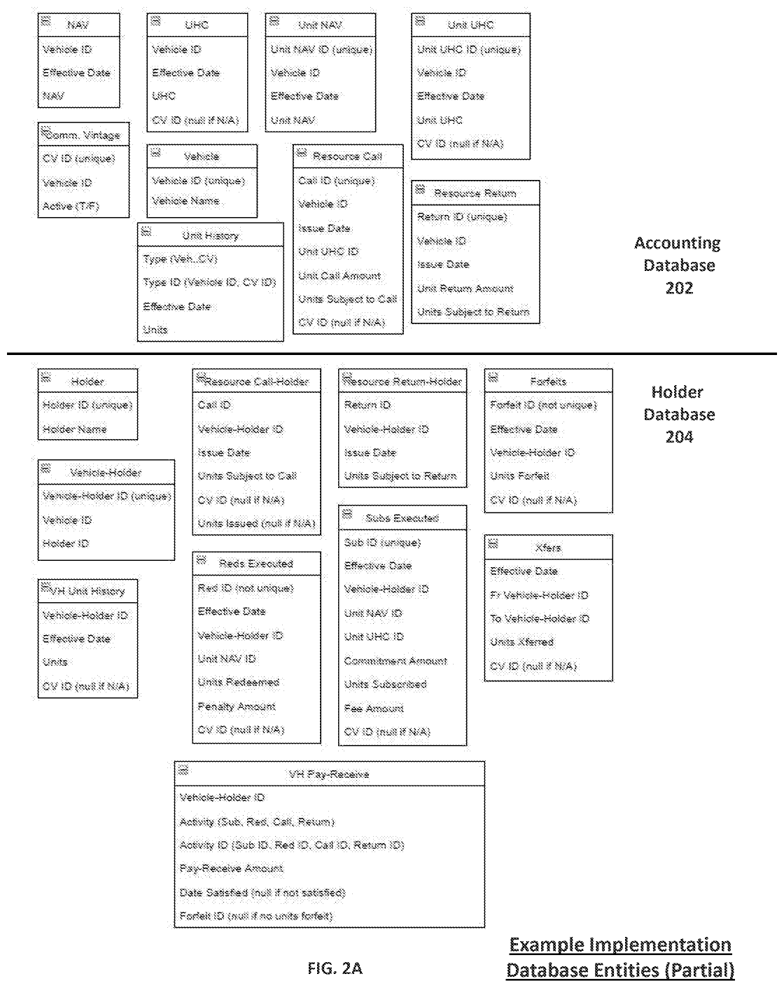

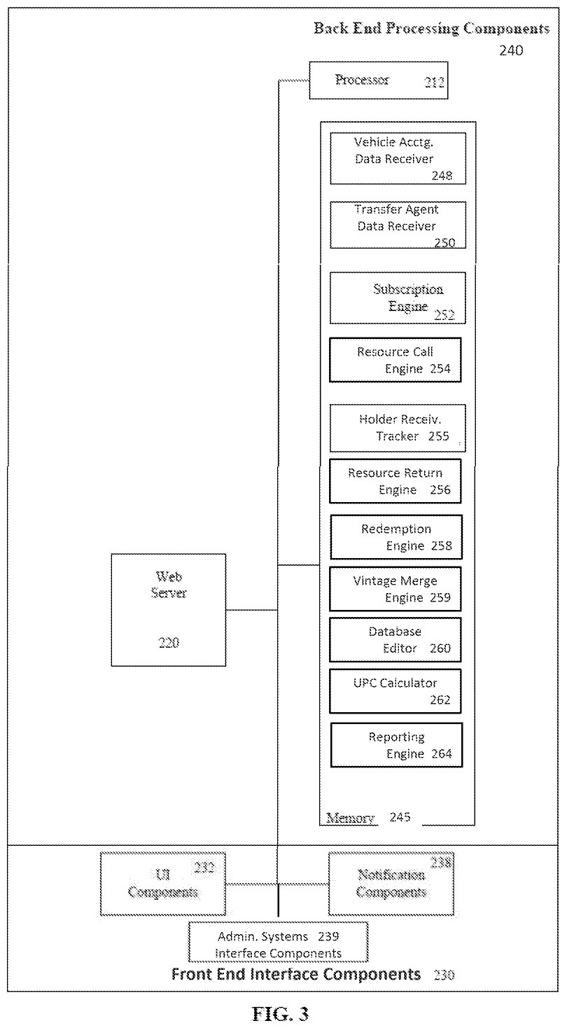

The enhanced recordkeeping system 200 enables the faster, e.g., in real time or near-real time, and more efficient, e.g., using fewer computer resources, administration of a unitized collective investment vehicle, operated as an illiquid drawdown vehicle with a portfolio comprised of illiquid private market assets as well as those liquid assets needed to support drawdown vehicle operations and to respond to impending resource calls to support underlying investments. The enhanced recordkeeping system 200 is further illustrated in FIG. 2, FIG. 2A and FIG. 3 and is described in greater detail below.

FIG. 1D shows an exemplary high-level structure of a unitized private market collective investment vehicle for which the enhanced recordkeeping system 200 enables efficient administration. According to one implementation, the system is employed in the administration of at least one illiquid drawdown vehicle 10, which will invest in an underlying illiquid drawdown vehicle portfolio 11. The underlying illiquid drawdown vehicle portfolio 11 may include direct investment in debt and/or equity of private companies or public companies whose debt or equity is illiquid, and/or other forms of illiquid investments. The illiquid drawdown vehicle portfolio may directly invest in limited partnerships or other co-mingled vehicles. Subscriptions to the illiquid drawdown vehicle 10 are made in the form of uncontributed resource commitments, which the system standardizes by converting to a corresponding quantity of units, using a unit NAV, a scaled value reflecting the NAV of each single unit held by every drawdown vehicle holder, and a unitized UHC, a scaled value reflecting the UHC of each single unit held by every drawdown vehicle holder (i.e., the drawdown vehicle unit UHC) or held by every holder of a given commitment vintage (i.e., the commitment vintage unit UHC). In some implementations, the underlying illiquid drawdown vehicle portfolio 11 will include assets 16 that have their own associated uncontributed resource commitments.

FIG. 2, FIG. 2A and FIG. 3 illustrate further details of the enhanced recordkeeping system 200 in accordance with implementations of the system. A computing environment 210 may include a web server 220, front end interface components 230, and back end processing components 240. The computing environment 210 may include or have access to multiple storage areas including an accounting database 202 and a holder database 204.

The accounting database 202 stores data reflecting a unitized private market collective investment vehicle's investment portfolio and non-investment financial data, including data provided by a vehicle accounting system 50 in the administration of the form of investment vehicle shown in FIG. 1D. The holder database 204 stores data relating to a unitized, private market collective investment vehicle's holders including data provided by a transfer agent system 60 in the administration the form of investment vehicle shown in FIG. 1D. The database entities shown in FIG. 2A may be employed in an implementation of the system as described herein. Other database entities not shown in FIG. 2A may also be employed. These databases reflect logical organizations that may be physically resident on a single set of electronic storage media or resident on electronic storage media distributed across a network and accessible as complete data sets. The two datasets 202 and 204 may store all data necessary to fully implement and record the activities of the system in administering unitized private market collective investment vehicles.

The stored data may be structured, semi-structured, or unstructured. The data storage areas may include file systems and databases for storing large amounts of data. For example, the data storage areas may include HP 3PAR StoreServ® Storage systems. Those of ordinary skill in the art will appreciate that other computer storage systems for storing large amounts of data may be implemented. Data stored in the data storage areas may be managed and communicated with an Object-Relational Database Management System, such as Postgres® or other Object-Relational Database Management Systems that are known in the art. Multiple data storage areas may have different structures and store different types of data. For example, unstructured data may be stored separately from cleansed and structured data.

The web server 220 may include server software and/or hardware dedicated to running the software that can serve contents to the world wide web or other types of networks. The web server 220 may process incoming requests over Hypertext Transfer Protocol (HTTP) or other protocols from connected devices such as the subscribing participant devices or other computing systems. The web server 220 will deliver web pages to clients, potentially as HTML documents. The web server 220 may also receive content such as web forms and uploaded files.

FIG. 3 illustrates further details of the front end interface components 230 and the backend processing components 240 in accordance with implementations of the system. The front end interface components 230 may include, for example user interface (UI) components 232, notification components 238 and admin systems interface components 239. The components 232 and 238 may interact with the web server 220 to accept subscriber input through a provided web site or other hosting platform and provide notifications through the platform or by generating email messages, text messages, or other types of automated notifications. The components 232 and 238 may utilize and interact with a public facing, secured internet web site; a secured mobile application installed on a phone, tablet or laptop; secured e-mail; and secured FAX; any of which may be used for holder-initiated actions and communication. The user interface components 232 may provide specialized interfaces accessible to subscribing participant systems and other systems connected over the network for obtaining information or submitting requests related to redemptions, distributions, subscriptions, or other operations for a unitized private market collective investment vehicle such as the described illiquid drawdown vehicle. The notification components 238 may be capable of generating notifications, responsive to functions performed by the backend processing components 240 or to external events. The notifications may include text messages, email notifications, push notifications, or pop-ups for notifying subscribing participants of events or actions required. The notifications may include embedded URLs generated by the web server 220 to allow subscribing participants systems to view specific information or interact with specific applications. The admin systems interface components 239 may provide specialized interfaces to exchange data with and provide notifications to a vehicle accounting system 50, a transfer agent system 60, and other administration systems, as well as to disseminate information to 3rd party systems.

The backend processing components 240 may include one or more processors 212 that may access memory 245 to execute code modules stored in the memory to perform multiple functions. The back end processing components 240 as illustrated also include a vehicle accounting data receiver 248, a transfer agent data receiver 250, a subscription engine 252, a resource call engine 254, a holder receivable tracker 255, a resource return engine 256, a redemption engine 258, a vintage merge engine 259, a database editor 260, an Uncontributed Portfolio Commitment (UPC) calculator 262 and a reporting engine 264. Backend processing components may be invoked directly by operational personnel or automatically in response to external events. In addition, some components may invoke other components as indicated below and in related figures. The system embodies the concept of unitization in administering unitholders' uncontributed resource commitments. As such, a unitized uncontributed holder commitment (UHC), common to all vehicle holders or common to all holders of a given commitment vintage, plays a prominent role in the resource interchanges between an illiquid drawdown vehicle and its holders, and therefore plays a determinative role in several backend processing components. Other code modules or processors may be included. In implementations of the system, a single processor executes code stored in the memory to perform the various functions.

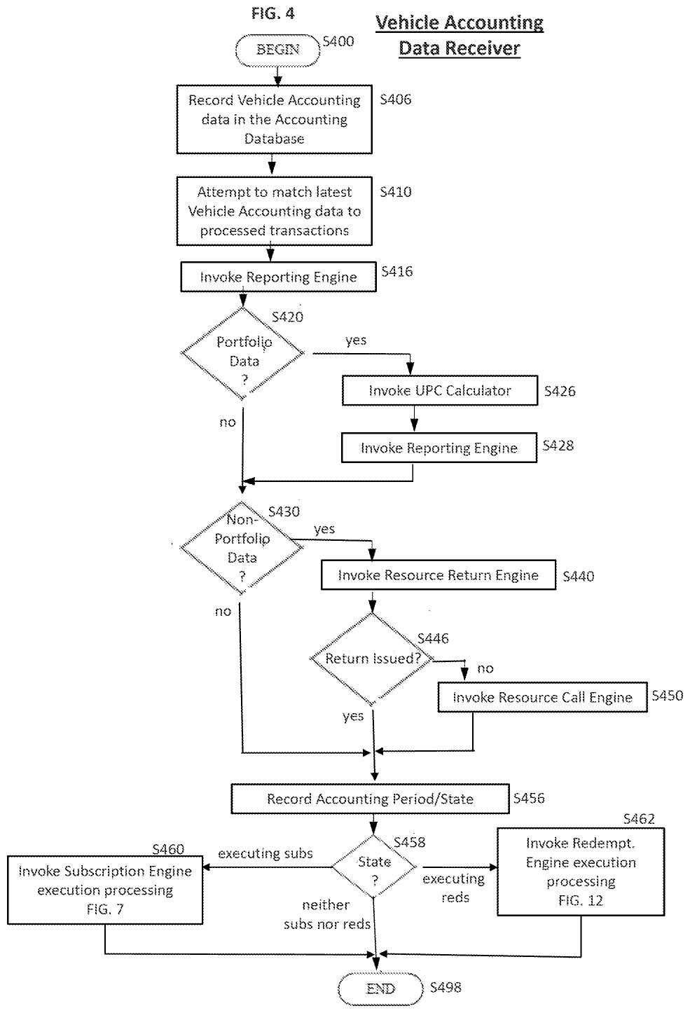

The vehicle accounting data receiver 248 responds to the receipt of accounting data from a vehicle accounting system 50 by recording the received accounting data in the accounting database 202, attempting to match previously executed, unreconciled transactions with the data received and invoking the Reporting Engine 260 to generate a vehicle accounting reconciliation report. Additionally, the vehicle accounting data receiver may invoke other back end processing components 240 as appropriate, according to the data received. Vehicle accounting data may be categorized as: portfolio related data (including data related to purchases, sales, resource activities and valuations of portfolio assets, gains and income realized) or non-portfolio data (including cash balances, receivables, payables, debt as well as gains and income distributed). The vehicle accounting data receiver 248 also records the state of the current accounting period in order for the subscription engine 252 and the redemption engine 258 to align their activities with that state. Further details of the operation of the vehicle accounting data receiver 248 are described below with reference to FIG. 4. In some implementations, the enhanced recordkeeping system 200 functions may be incorporated into a vehicle accounting system 50. In such implementations the accounting database 202 would be merged with the vehicle accounting system's existing databases and a vehicle accounting data receiver 248 would have a reduced functional scope.

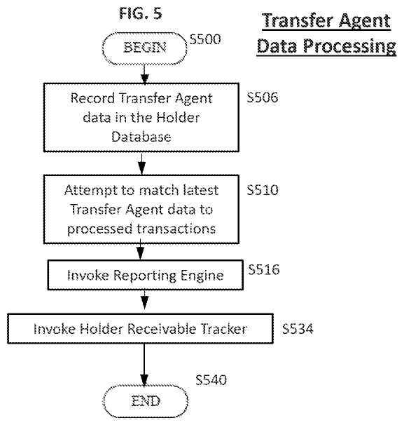

The transfer agent data receiver 250 responds to the receipt of holder data from a transfer agent system 60 by recording the received data in the holder database 204, attempting to match previously executed, unreconciled transactions with the data received and invoking the Reporting Engine 260 to generate a transfer agent reconciliation report. Additionally, given that transfer agent activity may include activity related to receivables resulting from subscriptions or resource calls, the transfer agent data receiver 250 invokes the holder receivable tracker 255. Further details of the operation of the transfer agent data receiver 250 are described below with reference to FIG. 5. In some implementations, the enhanced recordkeeping system 200 functions may be incorporated into a transfer agent system 60. In such implementations the holder database 204 would be merged with the transfer agent system's existing databases and a transfer agent data receiver 250 would have a reduced functional scope.

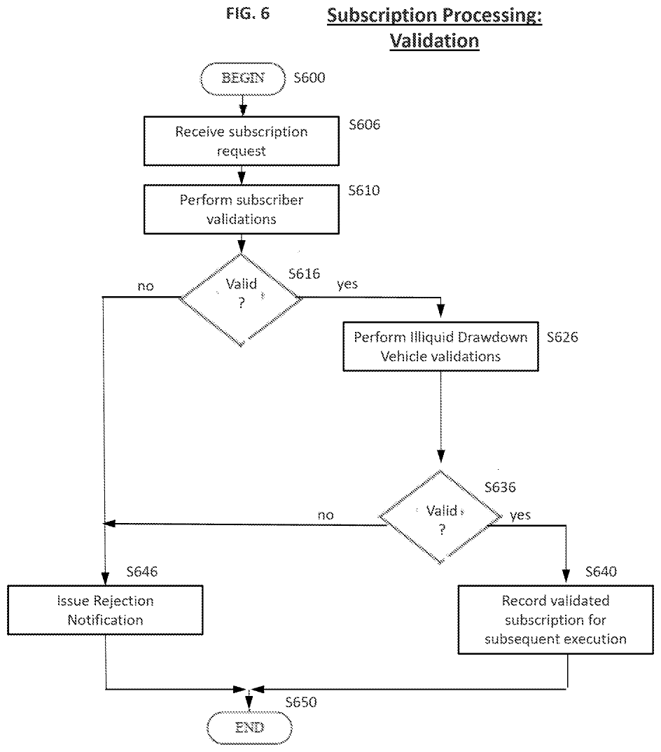

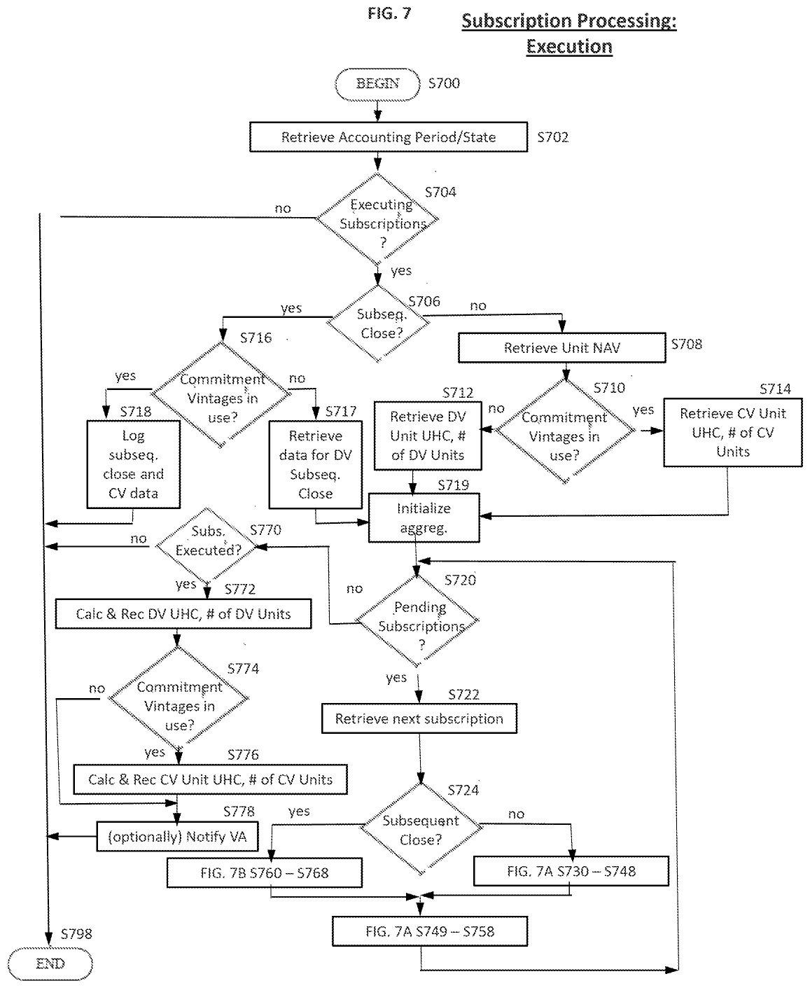

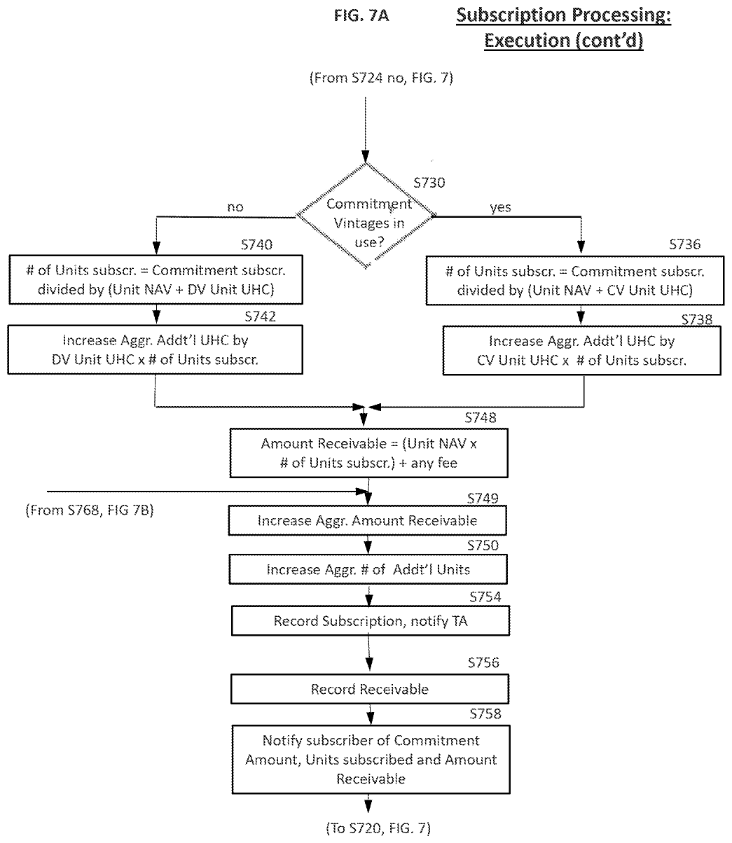

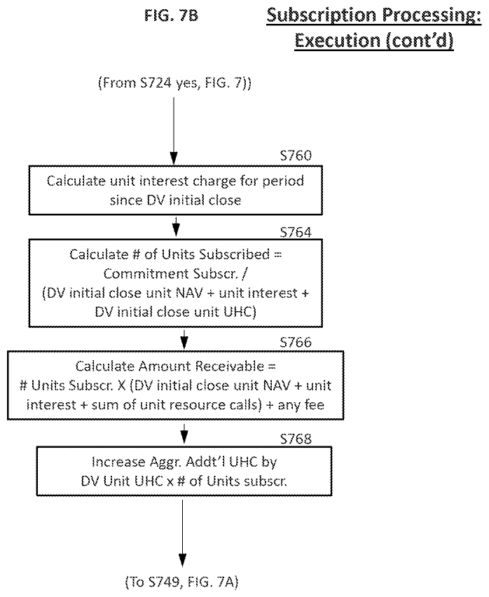

The subscription engine 252 accepts subscriptions, provided via subscribing participant devices, to the form of unitized private market collective investment vehicle supported by the system. The subscription engine 252 accepts subscriptions in the form of uncontributed commitments, which the system, in order to enforce standardized scaling, converts to units calculated using a net asset value per unit (unit NAV) and uncontributed holder commitment per unit (unit UHC), which may be the drawdown vehicle unit UHC or the commitment vintage unit UHC; may trigger notifications to holders of their number of units subscribed, their associated unit NAV and drawdown vehicle unit UHC or commitment vintage unit UHC; and may issue resource calls as the amount receivable for units subscribed. The subscription engine 252 will record the activity and notify the Transfer Agent and Vehicle Accounting systems accordingly. Further details of the operation of the subscription engine 252 are described below with reference to FIG. 6, FIG. 7, FIG. 7A and FIG. 7B.

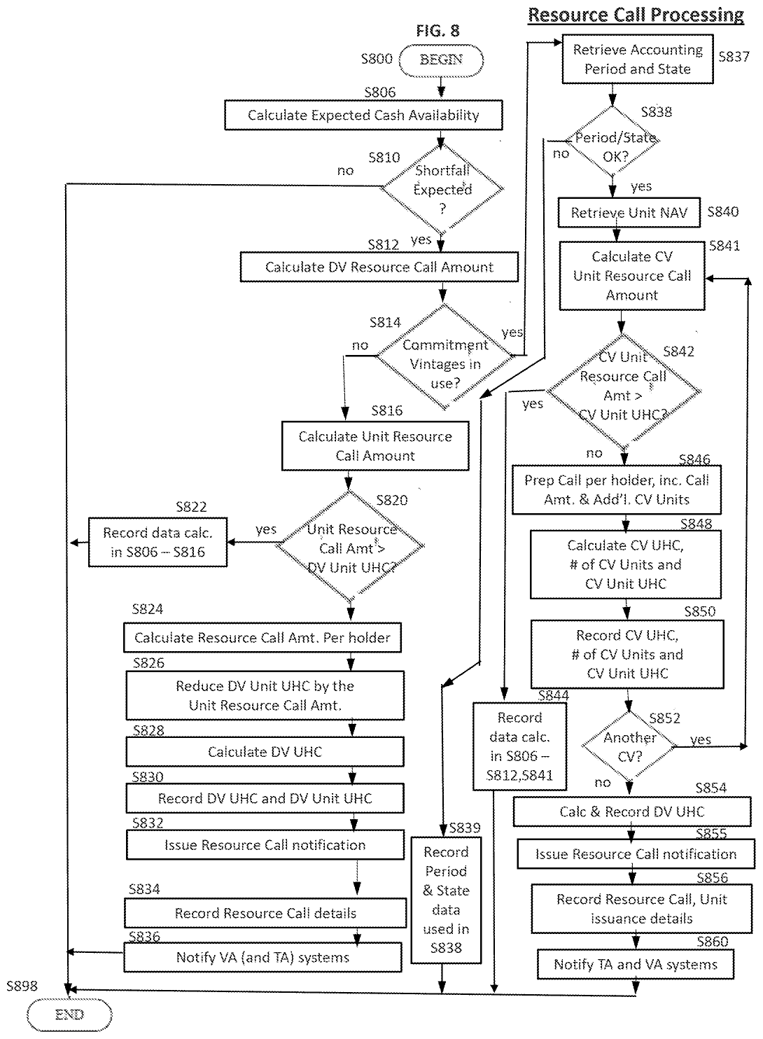

The resource call engine 254 operates to call resource from illiquid drawdown vehicle holders. Consistent with the standardized scaling, the resource call engine 254 calls resource in an amount per unit, as needed to pay expenses of the illiquid drawdown vehicle and to apply to underlying illiquid assets, thereby decreasing drawdown vehicle UHC, commitment vintages' UHC if applicable and drawdown vehicle unit UHC or commitment vintages' unit UHC as applicable and causing an increase in NAV and unit NAV to be reflected by the vehicle accounting system 50 subsequently. A particular process that may be performed by the resource call engine 254 is further described below in connection with FIG. 8.

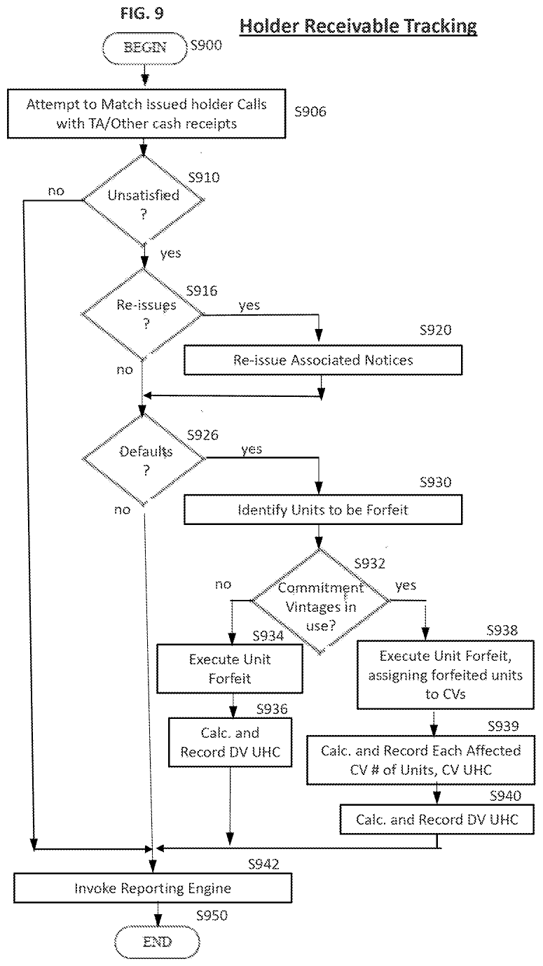

The holder receivable tracker 255 attempts to match holder remittances with receivables generated from resource calls to holders initiated by the resource call engine 254 and subscriptions executed by the subscription engine 252; re-issues receivable notices where indicated; executes unit forfeiture where indicated, so as to maintain the standardized scaling; and invokes the Reporting Engine 260 to generate a holder receivable reconciliation report. A particular process that may be implemented by the holder receivable tracker 255 is described below in connection with FIG. 9.

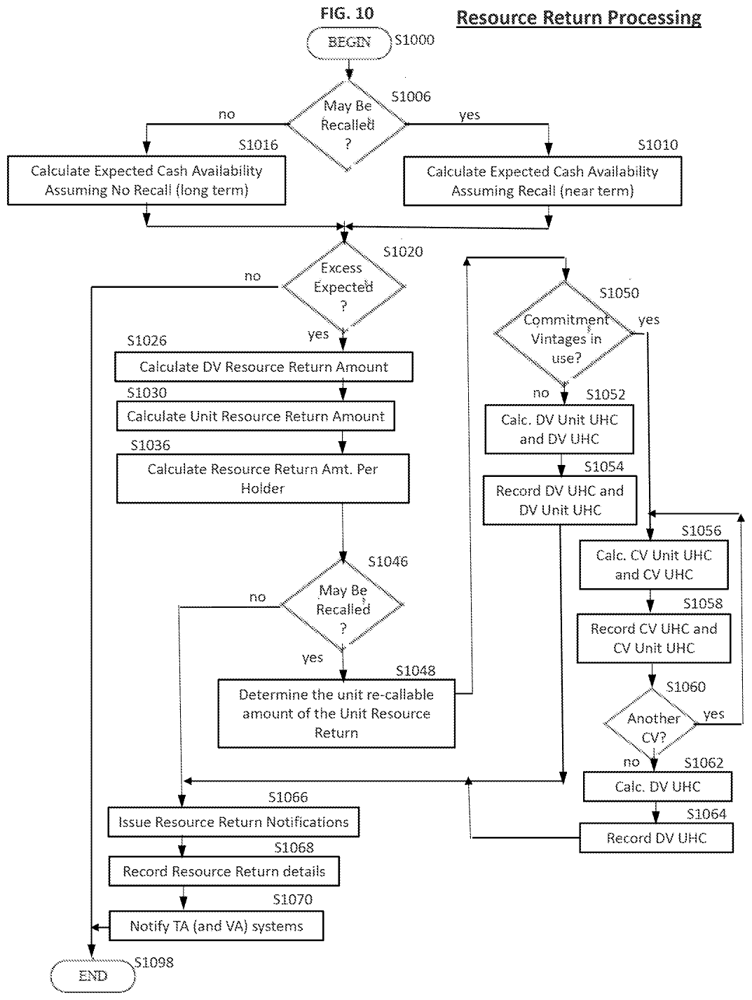

The resource return engine 256 is used in the administration of an illiquid drawdown vehicle. The resource return engine 256 considers the available resource in the form of cash and other liquid assets, and the prevailing conditions in determining whether and how much resource to return to holders. The resource return engine 258 may return resource in cash and equivalents to the holders in a unitized resource return amount per unit, enforcing the standardized scaling and thereby causing a decrease in unit NAV by the same amount per unit (and in aggregate in NAV) to be reflected by the vehicle accounting system 50 subsequently. The resource return engine also increases drawdown vehicle unit UHC or each commitment vintage unit UHC by the portion of the unitized resource return amount subject to re-call in a subsequent resource call (and increases drawdown vehicle UHC and each commitment vintage UHC if applicable by the associated aggregate amount reflective of the relevant units). Operations performed by the resource return engine 256 include notifying holders of resource returns and their associated impact (if any) on the applicable unit UHC(s). These operations are further described below in connection with FIG. 10.

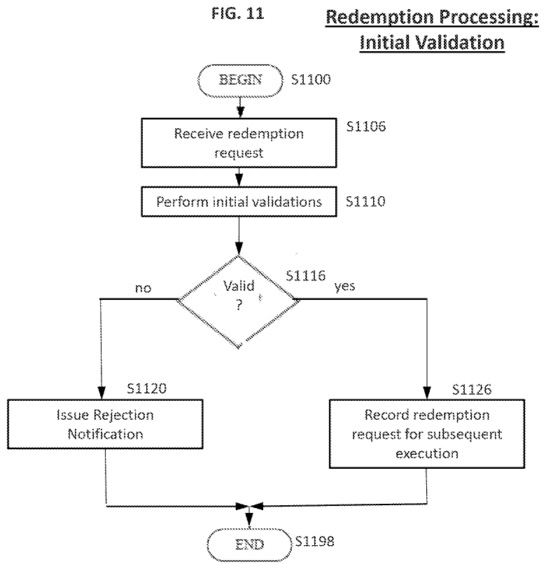

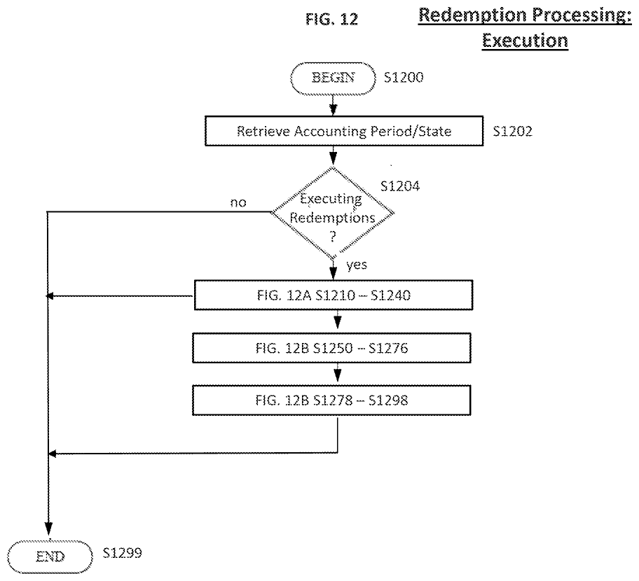

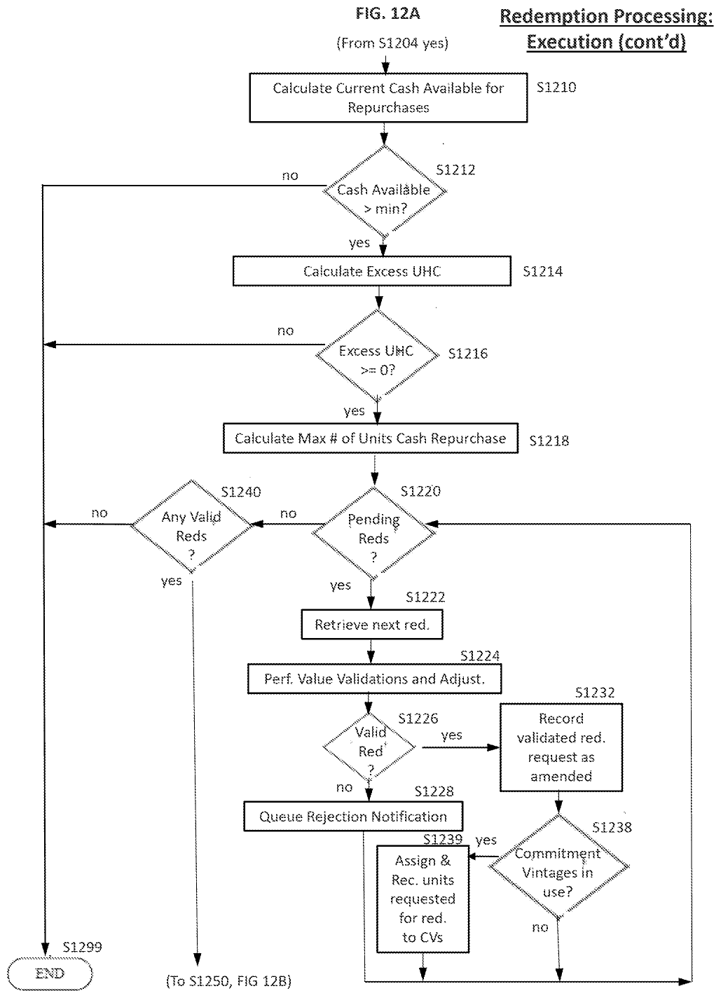

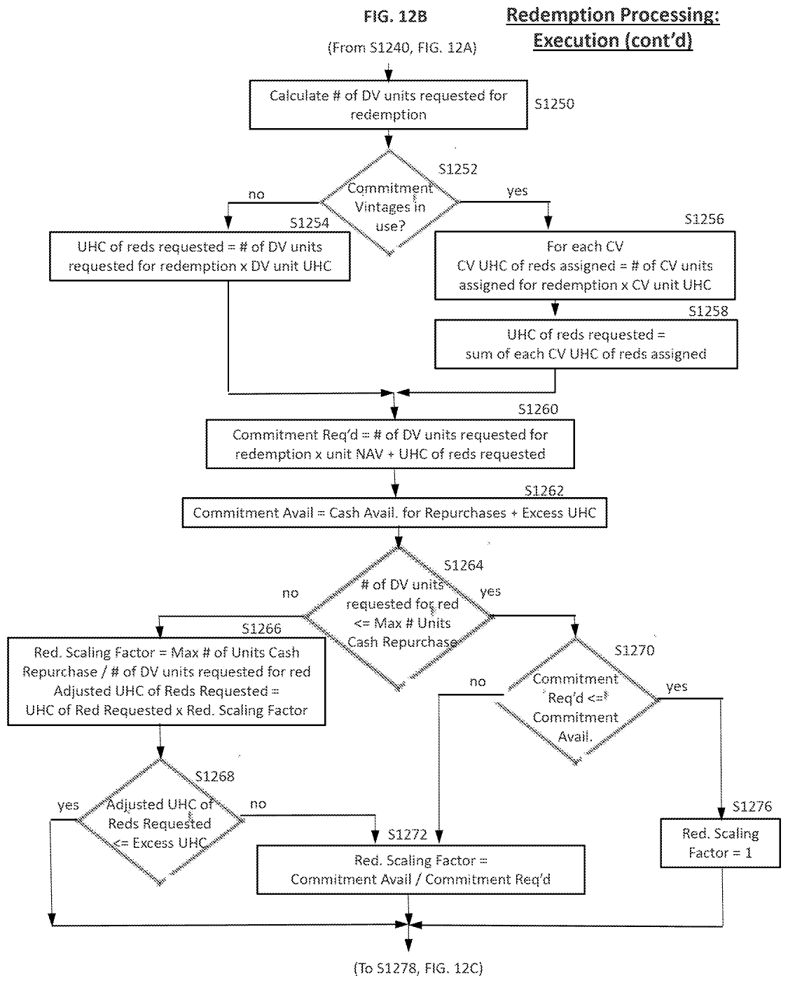

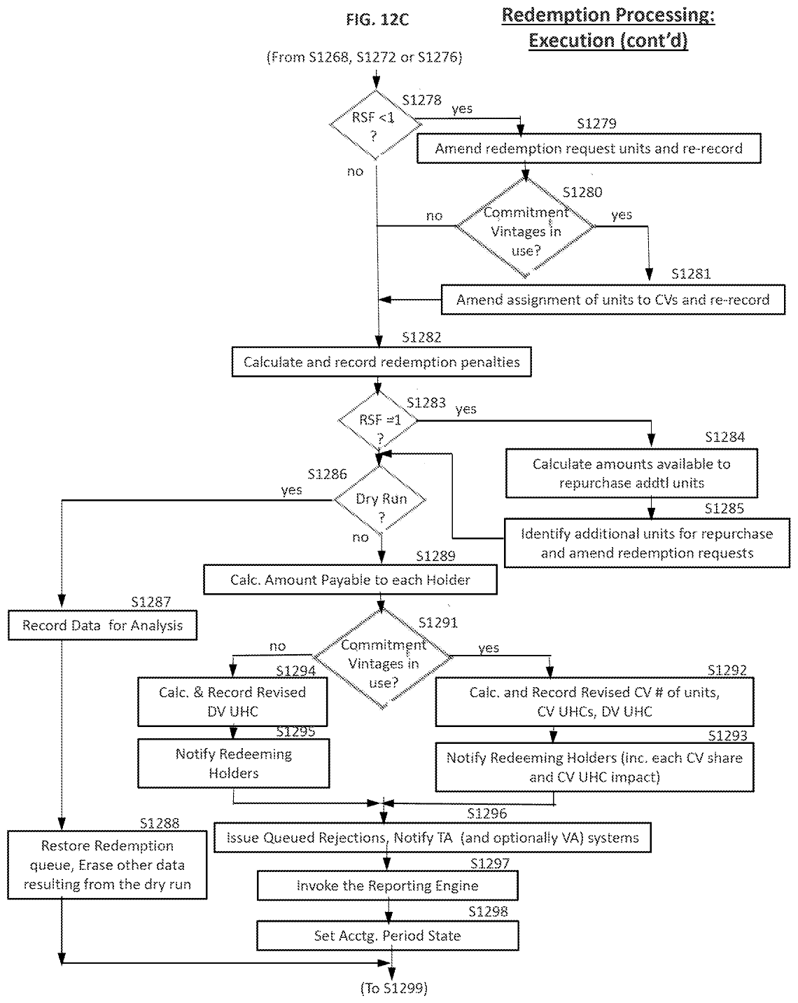

The redemption engine 258 may provide periodic opportunities for the holders to redeem their units. Redemptions may be processed as responses to a vehicle's tender offers to repurchase holder units. Redemption and repurchase opportunities may only be provided when the vehicle has sufficient liquid assets. Note that an illiquid drawdown vehicle may call resource specifically with the intention to use the liquid resource provided to redeem or repurchase units. The redemption engine 258 accomplishes redemptions or unit repurchases of some or all of a holder's vehicle units. When processing illiquid drawdown vehicle redemptions, in order to enforce the standardized scaling, drawdown vehicle UHC and commitment vintage UHC if applicable are recalculated to reflect a reduction of the UHC associated with each unit redeemed or repurchased (i.e., the associated unit UHC). A more detailed description of operations performed by the redemption engine 258 is provided below in connection with FIG. 11, FIG. 12, FIG. 12A, FIG. 12B and FIG. 12C. Also, given the unitized approach enabled by the system, transfers of vehicle interests from one holder to another may be executed via a simplified process, supported by functionally adjacent systems, including via digital tokens implemented with blockchain technology.

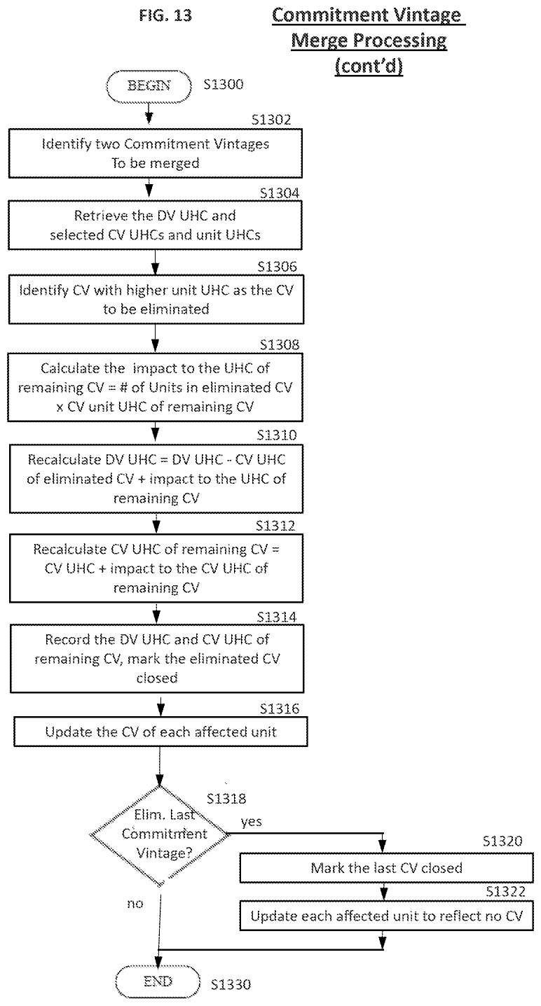

The vintage merge engine 259 may be invoked by operational personnel to merge two commitment vintages into a single commitment vintage. When commitment vintages are employed by a vehicle in its subscription process to limit dilution of existing holders, subsequent resource calls will reduce the disparity in unit UHC across commitment vintages. As the unit UHC of two commitment vintages approaches parity, a vehicle sponsor may choose to collapse the two vintages into a single vintage in order to make vehicle operations more efficient and to increase the fungibility of units. A more detailed description of the operations performed by the vintage merge engine 259 is provided below in connection with FIG. 13.

The database editor 260 is used by operational personnel in the administration of a unitized private market collective investment vehicle (e.g., an illiquid drawdown vehicle 10 as shown in FIG. 1D), to revise, eliminate or annotate processed transactions in the accounting database 202 and the holder database 204. Revisions and eliminations may be made in order to resolve unreconciled transactions (or aspects thereof) identified via a vehicle accounting reconciliation report, a transfer agent reconciliation report or a holder receivable reconciliation report. Annotations may be made to indicate that transactions have been reconciled and can therefore be omitted from subsequent reconciliation reports. Annotations may be made to resource call transactions to inform a subsequent invocation of the holder receivable tracker 255 to re-issue a subscription or resource call notice or to execute a unit forfeiture as a consequence of the failure of a holder to satisfy a receivable. In addition, the database editor may be used by operational personnel to augment the portfolio asset information supplied to the enhanced recordkeeping system 200 by a vehicle accounting system 50 via the vehicle accounting data receiver 248 and stored in the accounting database 202. The database editor 260 may be used to record and maintain specific attributes as applicable (e.g., liquid/illiquid, uncontributed commitment, vintage, geographic focus, investment strategy) associated with each portfolio asset. In addition, the database editor 260 may be used to record the sub assets (if applicable) associated with a given asset. The recorded portfolio asset attributes may be used by the reporting engine 264. The database editor may also be used to initially set or to reset certain system variables (e.g., UHC, unit UHC, commitment vintage UHC, commitment vintage unit UHC, commitment vintage number of units), as well as altering the commitment vintage, associated with particular holders' units. Via these capabilities of the database editor 260, commitment vintages may be created, and existing holder units assigned to a newly created commitment vintage or transferred between existing commitment vintages. Whenever commitment vintages are in use, there must be at least one commitment vintage with an associated commitment vintage UHC value and commitment vintage unit UHC value, with both values being greater than or equal to zero. At such times, the value of drawdown vehicle unit UHC is inconsequential to the operation of the system.

The UPC calculator 262 relies on portfolio activity reflected in the accounting database 50 via the vehicle accounting data receiver 248 and database editor 260 to calculate the UPC of the unitized private market collective investment vehicle being administered. Whenever the vehicle being administered subscribes to, purchases or sells an underlying asset with an uncontributed resource commitment, the vehicle's UPC may be impacted. Each of these actions may be reflected in the vehicle accounting system 50 used to administer the vehicle and subsequently be reflected via the vehicle accounting data receiver 248 in the accounting database 202. In addition, whenever the vehicle satisfies a resource call or has previously contributed resource returned by such an asset, it may be reflected in the vehicle accounting system 50 and the accounting database, possibly as a change in the cost associated with the asset. However, in some implementations, depending on the available vehicle accounting records, the change in the uncontributed commitment to an underlying asset may not be discernable from vehicle accounting records alone. Finally, the uncontributed commitment to an underlying asset may be reduced by unilateral action by the underlying asset which may not be reflected in the vehicle accounting system 50, if for example the asset communicates that it will not call some amount of committed resource. Thus, both the vehicle accounting system via the vehicle accounting data receiver and the database editor 260 may be used to maintain the uncontributed commitment amount of each of an administered vehicle's illiquid portfolio assets. The UPC Calculator calculates an administered vehicle's UPC as the aggregate of the uncontributed commitments associated with the each of the vehicle's illiquid portfolio assets. The UPC Calculator records the UPC in the accounting database 202.

The reporting engine 264 may be configured to report to vehicle or administrative operational personnel, vehicle sponsors, investment advisors and holders. Information contained in the accounting database 202 and the holder database 204 may be reported. Reports may include a vehicle accounting reconciliation report, a transfer agent reconciliation report, a holder receivable reconciliation report, holder activity reports, portfolio reports and, in some implementations, a diversification report. The reconciliation reports display transaction data as matched and not matched with external sources by the vehicle accounting data receiver 248, the transfer agent data receiver 250 and holder receivable tracker 255, respectively. Holder activity reports may include holder subscription and redemption activity, as well as resource call and resource return activity by holder and in aggregate. Portfolio reports may include UPC, as well as a list of each vehicle asset, its value, its value as a percentage of the aggregate gross value of vehicle assets, its associated uncontributed commitment (if any), and its associated uncontributed commitment as a percentage of the vehicle's UPC. Reports may also include vehicle UHC and vehicle Unit UHC, as well as commitment vintage UHC and commitment vintage Unit UHC if applicable. Additional portfolio reports may include sub-aggregations of vehicle assets according to attributes recorded in the accounting database 202 and maintained via the database editor 260, the value of the sub-aggregations, the value of the sub-aggregations as a percentage of the aggregate gross value of vehicle assets, the associated uncontributed commitment of the sub-aggregations and the associated uncontributed commitment of the sub-aggregations as a percentage of the vehicle's UPC.

In some implementations, a unitized private market collective investment vehicle or a unit holder of such vehicle may be registered under the U.S. Investment Company Act of 1940 As Amended and intend to comply with Subchapter M of the U.S. Tax Code as a Regulated Investment Company (MC). Among other elements, compliance with Subchapter M requires that the Investment Company's portfolio be diversified as measured according to a proscribed diversification test. This diversification test measures the size of each of a vehicle's portfolio assets relative to the vehicle's aggregate gross assets. In some implementations, the reporting engine 264 may produce a diversification report to facilitate the conduct of the proscribed diversification test.

In the case of an illiquid drawdown vehicle taxed as a partnership, a unit holder that is a 1940 Act registered vehicle taxed as a RIC would conduct its diversification test as if its pro rata share of illiquid assets were held by it directly and were not segregated into the drawdown vehicle. As such, an illiquid drawdown vehicle may be managed co-operatively with subscribed 1940 Act registered vehicles in order to assist each subscribed 1940 Act registered vehicle to meet its Subchapter M diversification requirements. To facilitate such co-operative management, the reporting engine 262 may calculate a Diversification Minimum Basis to be used in the production of a diversification report, where the Diversification Minimum Basis is equal to the sum of the drawdown vehicle UHC multiplied by a specified Uncontributed Commitment Scaling Factor, and the aggregate gross value of drawdown vehicle assets (i.e., assets excluding liabilities). Stated more concisely,

$$Diversification Minimum Basis = DV UHC \times Uncontributed Commitment Scaling Factor + aggregate gross value of vehicle asssets . \qquad ( 7 )$$

The Uncontributed Commitment Scaling Factor is expected to be not less than zero and not greater than one, may be stored in the accounting database 202 and maintained via the database editor 260. The Uncontributed Commitment Scaling Factor accounts for the possibility that a subscribed 1940 Act registered vehicle's gross asset value (against which Subchapter M diversification may ultimately be measured) may be less than the sum of the value of the subscribed 1940 Act registered vehicle's pro rata portion of illiquid drawdown vehicle gross assets and the aggregate UHC of the illiquid drawdown vehicle units owned by the subscribed 1940 Act registered vehicle, reflecting an over-commitment by the subscribed 1940 Act registered vehicle to the illiquid drawdown vehicle. The Uncontributed Commitment Scaling Factor may also account for the possibility that a subscribed 1940 Act registered vehicle may desire to use less than the aggregate UHC of the drawdown vehicle units it owns when measuring its diversification. An illiquid drawdown vehicle may be operated with the intention of complying with Subchapter M diversification requirements and qualifying as a RIC itself. In that circumstance, the reporting engine 264 may use an Uncontributed Commitment Scaling Factor of zero when measuring the illiquid drawdown vehicle's diversification. Consistent with Subchapter M, the diversification report may, using attributes recorded in the accounting database 202 and maintained via the database editor 260, divide a single illiquid drawdown vehicle asset, depending on the asset's tax treatment (e.g., taxed as a partnership), into sub-holdings, and divide sub-holdings (depending on the sub-holding's tax treatment) into further sub-holdings and so on, for the purpose of preparing a diversification report. According to one implementation, the diversification report may list the aggregate value of drawdown vehicle assets, the UHC, the Uncontributed Commitment Scaling Factor, the Diversification Minimum Basis, each vehicle asset (and its sub-holdings if applicable), the current value of the asset (and its sub-holdings if applicable and available), and the ratio of each asset value to the Diversification Minimum Basis.

The web server 220 described above may make the reports produced by the reporting engine 264 available at a specific URL and the notification components may generate a notification of the availability including an embedded URL.

The components identified in FIG. 2 and FIG. 3, collectively describing the enhanced record keeping system, may be used to apply the data standardization approach in the administration of a vehicle as shown in FIG. 1D, in which the illiquid drawdown vehicle 10 has a portfolio 11 comprised of multiple assets 16, one or more of which may be a private market fund administered using non-standardized, individual multi-component accounts. These system components may also be used to apply the standardization approach in the administration of a vehicle as shown in FIG. 1E, in which the illiquid drawdown vehicle 10 has a portfolio 11 comprised of a single asset 16′, an illiquid drawdown vehicle administered using non-standardized, individual multi-component accounts. In such a configuration, the illiquid drawdown vehicle 10 is reflected as a single individual multi-component account in the administration of the underlying vehicle 16′, allowing the illiquid drawdown vehicle 10 and its unit holders to derive the previously identified benefits of standardization, e.g., reduced storage requirements, reduced computational requirements, distributed reporting and efficiency of transfer, while avoiding the relative inefficiencies in administration, as well as the misinformation, confusion and greater potential for reporting error associated with the individual multi-component accounts used in the administration of the underlying vehicle 16′.

FIG. 4 is a flow chart illustrating a method by which the vehicle accounting data receiver 248 processes data received from a vehicle accounting system 50 in accordance with an implementation of the system. The method begins in S400. In S406, the data received from the vehicle accounting system 50 is recorded in the accounting database 202. The data received and recorded may include: portfolio data, such as each portfolio asset, its value and associated number of units, as well as quantities and dates of purchases, sales and other resource activity (e.g. contributions and distributions) associated with portfolio assets since prior portfolio data was received; non-portfolio data, such as NAV, unit NAV, current cash balances, receivables, payables and debt, as well as activity related to those items including associated amounts and dates, since prior non-portfolio data was received; and the effective date of the data received. In S410, the system attempts to match the data received with subscription, redemption, resource call and resource return transactions previously executed. Subscriptions and resource calls may be matched to cash and cash equivalents received and receivable. Redemptions and resource returns may be matched to cash and cash equivalents paid and payable. In S416, the system invokes the reporting engine 264 to generate a vehicle accounting reconciliation report. In S420, the system determines whether the current data received from the vehicle accounting system 50 includes updated portfolio data. If not, the process continues in S430. Otherwise, in S426 the system invokes the UPC calculator. In S428, the system invokes the reporting engine to produce portfolio reports and, in some implementations, a diversification report. In S430, the system determines whether the current data received from the vehicle accounting system 50 includes updated non-portfolio data. If not, the process continues in S456. Otherwise, in S440 the system invokes the resource return engine 256. In S446, the system determines whether the invocation of the resource return engine resulted in a resource return being issued. If no resource return was issued by the resource return engine, in S450 the system invokes the resource call engine 254. In either case, the process resumes with S456. In S456, based on information provided by the vehicle accounting system 50, the system records the current accounting period and the state of that period in the accounting database 202, where states may include: executing (start of period) subscriptions, open, executing (end of period) redemptions, redemptions completed and close completed. In S458, the system examines the current state of the accounting period. If the state is executing subscriptions, in S460 the system invokes the subscription engine to execute subscriptions, as shown in FIG. 7, and the process completes in S498. If the state tested in S458 is executing redemptions, in S462 the system invokes the redemption engine execution processing, as shown in FIG. 12, to execute redemptions and the process completes in S498. If the state tested in S458 is neither executing subscriptions, nor executing redemptions, the process completes in S498.

FIG. 5 is a flow chart illustrating a method by which the transfer agent data receiver 250 processes data received from a transfer agent system 60 in accordance with an implementation of the system. The method begins in S500. In S506, the data received from the transfer agent system 60 is recorded in the holder database 204. The data received and recorded may include: identifying information for current holders and their associated current number of units; dates, quantities and prices of units purchased, redeemed (or re-purchased) and transferred, including any interests transferred via transfer agency system 60 related systems such as blockchain based transfers from the digital wallet of one holder to the digital wallet of another holder, as well as identifying information for the associated holders, any resource activity (e.g. resource contributed in response to resource calls, returns of resource, distributions of gains) recorded in the transfer agent system since prior transfer agent system data was received, and the effective date of the data received. In S510, the system attempts to match the data received with subscription and redemption transactions previously executed. In some implementations, where the transfer agent system 60 records holder resource activity corresponding to resource returns, the system will attempt to match the resource return activity provided by the transfer agent system with resource returns previously executed. In S516, the system invokes the reporting engine 264 to generate a transfer agent reconciliation report. Given that transfer agent activity may have related resource call activity, in S534, the system invokes the holder receivable tracker 255. The process completes in S540.

The subscription engine 252 consists of two processes: a subscription validation process and a subscription execution process. The subscription validation process is executed in response to receipt of a subscription request and ends with the request being rejected or being recorded for execution at an appropriate time. FIG. 6 is a flow chart illustrating a subscription validation process in accordance with an implementation of the system. The process begins in S600. In S606 the system receives a subscription request. In S610, the system performs validations that are applicable to the subscriber. These validations may include validation of the subscriber's identifying information and any requisite subscriber qualifications. In S616, the system determines whether the subscription request met these subscriber validations. If not, the process continues in S646. If the subscriber validations were met, in S626 the system performs validations that are specific to subscription requests for illiquid drawdown vehicle being administered. For example, to enforce the standardized scaling, an illiquid drawdown vehicle subscription request must specify a commitment amount, and a given vehicle may have a minimum commitment amount.

In S636, the system determines whether the subscription request met the validation criteria specific to the illiquid drawdown vehicle. If the subscription request met the validation criteria, in S640 the system records the validated subscription request as a pending subscription in the holder database 204. Otherwise, in S646 the system issues a subscription rejection notification, specifying the reason for rejection. The rejection notification may be distributed by the notification components of the system in the form of a text message, push notification, email, etc., with an embedded link leading to subscription details and reason for rejection. The subscription validation process completes in S650.

FIG. 7, FIG. 7A and FIG. 7B are flow charts illustrating a subscription execution process in accordance with an implementation of the system. This subscription process enforces and maintains the relationship between a holder's number of units and their UHC, as reflected by the drawdown vehicle unit UHC or a commitment vintage unit UHC, as applicable. This relationship among others enables the system to provide efficiencies over current systems. The process begins on FIG. 7 in S700. In S702 the system retrieves the current accounting period and the state of that accounting period from the accounting database 202. In S704, the system determines whether the state of the accounting period is “executing subscriptions”. If not, the process ends in S798. Otherwise, in S706 according to the setting in the holder database 204, the system determines whether subscriptions are being processed in the manner of a “subsequent close”. A subsequent close is a process by which later holders are provided financial subscription terms similar to the holders that subscribed in the vehicle's initial close. If so, processing continues in S716. Otherwise, in S708 the system retrieves the Unit NAV of the vehicle being administered and corresponding to the period for which subscriptions are being processed from the accounting database 202. In S710, the system determines whether commitment vintages are in use (i.e., there is at least one existing commitment vintage). If not, in S712 the system retrieves the drawdown vehicle unit UHC of the vehicle being administered and corresponding to the period for which subscriptions are being processed as well as the number of drawdown vehicle units from the accounting database, and processing continues in S719. Otherwise, in S714, the system retrieves the commitment vintage unit UHC and associated number of the commitment vintage units for the vehicle and corresponding to the period and commitment vintage for which subscriptions are being processed from the accounting database. Subscriptions to the most recently created existing commitment vintage or another vintage may be processed according to operating practice. Processing continues in S719.

If in S706, the system determined that subscriptions were being processed in the manner of a subsequent close, in S716 the system determines whether commitment vintages are in use. If not, in S717 the system retrieves data from the holder database 204 in order to process subsequent close subscriptions for the drawdown vehicle. The data retrieved may include the unit NAV and the unit UHC applied in the initial close of the drawdown vehicle, the drawdown vehicle unit UHC corresponding to the period for which subscriptions are being processed, the unit resource call amount of each resource call issued following the initial close of the vehicle, the dates of the initial close and each following resource call, as well as one or more interest rates that will be used to reflect subscribing holders' delay in making resource contributions relative to subscribers in the initial close of the drawdown vehicle. Then processing will continue in S719. If in S716, the system has determined that commitment vintages are in use, an error has occurred and in S718, the system will log subsequent close and commitment vintage data retrieved from the holder database in temporary storage. Then processing will terminate in S798. Note: the use of a subsequent close is intended to address situations in which a drawdown vehicle allows additional holders to subscribe while it has not yet developed a significant portfolio of appreciating assets and thus may have absorbed relatively high expenses relative to its portfolio of assets, thereby depressing unit NAV. This phenomenon is known as the “J curve” effect. Under such conditions, if new holders subscribed at a current unit NAV, they would benefit to the detriment of existing holders. The use of commitment vintages is intended to protect existing holders in an established portfolio of assets from the dilutive effect of new subscriptions. Thus, these two conditions and approaches are mutually exclusive.

In S719, aggregations of additional units subscribed, their corresponding additional UHC and amounts receivable are initialized to zero. In S720, the system determines whether there are any pending vehicle subscriptions for the current accounting period in the holder database 204. If not, processing continues in S770. If there are pending subscriptions for the current accounting period, in S722, the system retrieves the next pending subscription for processing. In S724 the system determines whether subscriptions are being processed in the manner of a subsequent close. If so, the process continues in S760 (FIG. 7B). Otherwise, the process continues in S730 (FIG. 7A).

In S730, the system determines whether commitment vintages are in use. If so, in S736, the system calculates the number of units subscribed using the commitment vintage unit UHC retrieved in S714 where

No. of Units Subscribed=Commitment Subscribed/(Unit NAV+CV Unit UHC) (8)

In S738, to enforce the standardized scaling, the system calculates a revised aggregate additional UHC where

Revised Aggregate Addt'l UHC=Aggregate Addt'l UHC+CV Unit UHC×No. of Units Subscribed (9)

If in S730 the system determines that commitment vintages are not in use, in S740 the system calculates the number of units subscribed where

No. of Units Subscribed=Commitment Subscribed/(Unit NAV+DV Unit UHC) (10)

In S742, to enforce the standardized scaling, the system calculates a revised aggregate additional UHC where

Revised Aggregate Addt'l UHC=Aggregate Addt'l UHC+DV Unit UHC×No. of Units Subscribed (11)

In S748, the system calculates an amount due for the subscribed units where

Amount Receivable=(Unit NAV×No. of Units Subscribed)+any placement fee (12)

Depending on the implementation, placement fees may be assessed on the basis of the number of units subscribed and the unit Nav, or the subscribed commitment amount, or a combination of these and/or other parameters. In S749, the system calculates a revised aggregate amount receivable where

Revised Aggregate Amount Receivable+Amount Receivable (13)

In S750, the system calculates a revised aggregate number of additional units where

Revised Aggregate No. of Addt'l Units=Aggregate No. of Addt'l Units+No. of Units Subscribed (14)

In S754 the system records the subscription in the holder database 204, including the vehicle, units subscribed, the association to a commitment vintage if applicable, effective subscription date with appropriate references to applicable unit NAV and unit UHC in the accounting database 202 and to the holder in the holder database 204. Also, the system notifies the transfer agent system 60, providing the holder identifying information, number of units subscribed and effective subscription date as a minimum, and in some implementations may notify the transfer agency system 60 of the holder and amount due. In S756, the system records the amount receivable from the holder in the holder database 204, with appropriate references to the holder, vehicle and executed subscription. In S758, the system notifies the subscriber of the amount of the subscribed commitment, the number of units subscribed, the amount receivable and the effective date of the subscription, as a minimum. If commitment vintages are in use, the holder notification includes the commitment vintage designation of subscribed commitment. Depending on the method of notification, additional information such as corresponding unit NAV, the corresponding unit UHC (the drawdown vehicle unit UHC or the commitment vintage UHC as appropriate) may also be provided. These holder notifications may be distributed by the notification components of the system via subscribing participant systems 30 or in the form of a text message, push notification, email, etc., with an embedded link leading to stored specified parameters of the subscriptions and calls. In some implementations, the operational staff may subsequently satisfy the receivable via transfer agency system 60 related systems which may include blockchain based smart contracts which transfer cash equivalent holdings from the blockchain digital wallets of holders to a digital wallet of the drawdown vehicle. The process continues in S720 to determine whether there are additional pending subscriptions for the current accounting period to be processed.

In S760, the system, using the data retrieved in S717, calculates a unit interest charge reflecting the amount contributed per unit, including upon subscription and all resource calls, since the drawdown vehicle's initial close, and the time elapsed since holders at the drawdown vehicle's initial close made those contributions. This calculation may be implemented differently in various implementations of the system. In S764, the system calculates a number of units subscribed where

No. of Units Subscribed=Commitment Subscribed/(DV initial close unit NAV+unit interest charge+DV initial close unit UHC) (15)

In S766, the system calculates an amount receivable where

Amount Receivable=No. Units Subscribed×(DV initial close unit NAV+unit interest charge+sum of the unit resource call amounts for all resource calls issued since the DV initial close)+any placement fee (16)

In S768, to enforce the standardized scaling, the system calculates a revised aggregate additional UHC, using the same formula as used in S742. Processing continues in S749.

In S770, the system determines whether any subscriptions were executed, i.e., whether the aggregate number of additional units is greater than zero. If not, processing terminates in S798. Otherwise in S772, the system calculates a revised drawdown vehicle number of units as well as a revised drawdown vehicle UHC and records these values in the accounting database with the effective date of the subscriptions, where

Revised DV No. of Units=DV No. of Units+Aggregate No. of Addt'l Units (17)

and

Revised DV UHC=DV UHC+Aggregate Addt'l UHC (18)

In S774, the system determines whether commitment vintages are in use, if not processing continues in S778. Otherwise in S774, the system calculates a revised commitment vintage number of units as well as a revised commitment vintage UHC and records these values in the accounting database for the given vehicle and commitment vintage with the effective date of the subscriptions, where

Revised CV No. of Units=CV No. of Units+Aggregate No. of Addt'l Units (19)

and

Revised CV UHC=CV UHC+Aggregate Addt'l UHC (20)

In S778, in some implementations, the system may notify the vehicle accounting system 50 of the aggregate number of additional units subscribed and the aggregate amount receivable. Processing terminates in S798.

FIG. 8 is a flow chart illustrating the resource call process performed by the resource call engine 254 of the system in accordance with implementations of the system. This resource call process enforces and maintains the relationship between a holder's number of units and their UHC, as reflected by the drawdown vehicle's unit UHC or a commitment vintage unit UHC. This process also creates the relationship between and holder's number of units and their resource call amount, as reflected by a unit resource call amount. These relationships enable the system to provide efficiencies over current systems. The process begins in S800. In S806, the system calculates the expected cash availability for the vehicle being administered. Various implementations may use different algorithms for this calculation. Variables used in these algorithms may include the vehicle's current cash balance, payables, debt, receivables, value of liquid and illiquid portfolio holdings, realized gains and income yet to be distributed, whether and with what frequency the distribution policy of the vehicle requires realized gains and income to be distributed and the UPC recorded in the accounting database 202. Additional variables may include a factor to reflect the percentage of illiquid portfolio assets that may be harvested (net of expected illiquid portfolio investments) by the vehicle in the near term, a factor to reflect the percentage of UPC which may be called by underlying assets in the near term, planned near term vehicle unit repurchases and an estimate of vehicle fees and expenses that may be incurred in the near term. In S810, to identify an expected shortfall, the system compares the expected cash availability to a minimum expected cash threshold, which in some implementations may be stored in the accounting database 202 and maintained via the database editor 260. If the expected cash availability is less than the threshold, a shortfall is expected. If not, a shortfall is not expected, and the process terminates in S898. Otherwise, in S812 the system determines the amount of resource to be called by the vehicle. Various implementations may use different algorithms for this calculation. Variables used in these algorithms may include the expected shortfall identified in S810, a minimum resource call amount and an expected resource call default rate. In S814, the system determines whether commitment vintages are in use. If so, processing continues in S837. Otherwise, in S816, to enforce the standardized scaling, the system calculates a unit resource call amount where

Unit Resource Call Amount=Vehicle Resource Call Amount/No. of Vehicle Units (21)

and where the amount of resource to be called by the vehicle is as calculated in S812, and the number of vehicle units is as found in the accounting database 202. In some implementations, the unit resource call amount and vehicle resource call amount may be adjusted to reflect at least a minimum unit resource call amount. In S820, the system determines whether the unit resource call amount is greater than the drawdown vehicle unit UHC. If so, in S822 the system records the data calculated in S806, S810, S812 and S816 in a temporary database for off-line analysis, and the process terminates in S898. (Off-line analysis may indicate that the unit resource call amount must be reduced via the modification of impactful calculation parameters.) Otherwise the process continues in S824. In S824, the system determines an amount of resource to call from each holder from the holder's number of units in the drawdown vehicle being administered as contained in the holder database where for each holder i

Resource Call Amtᵢ=Unit Resource Call Amount×No. of Unitsᵢ (22)

In S826, in reflection of the resource call, the system reduces the drawdown vehicle Unit UHC by the unit resource call amount calculated in S816. In S828, to enforce the standardized scaling, the drawdown vehicle UHC is calculated where

DV UHC=DV Unit UHC×No. of Vehicle Units (23)

In S830, the system records the drawdown vehicle UHC and drawdown vehicle unit UHC in the accounting database 202. In S832, the system issues the resource call to holders. For each holder, the call includes identification of holder's number of units, and optionally the unit resource call amount and the holder's resource call amount depending on the notification method and destination. The call notifications may be distributed by the notification components of the system via subscribing participant systems 30 or in the form of a text message, push notification, email, etc., with an embedded link leading to stored specified parameters of the calls. In S834, the system records the details of the resource calls issued in S832. Holder specific detail is recorded in the holder database 204. The total amount receivable by the vehicle for the resource call is recorded in the accounting database 202. In S836, the system also notifies the vehicle administration system 50 of the total amount receivable by the vehicle. In some implementations, the system notifies also the transfer agency system 60 of the resource call details, including the unit resource call amount, each holder's number of units, their identifying holder information and optionally the resource call amount receivable from each holder. In some implementations, the operational staff will subsequently complete the resource calls in satisfaction of the receivables via transfer agency system 60 related systems which may include blockchain based smart contracts which transfer cash equivalent holdings from the blockchain digital wallets of holders to a digital wallet of the drawdown vehicle. The process terminates in S898.

If the system determines in S814 that commitment vintages are in use, processing continues in S837. In S837, the system retrieves the current accounting period and state of that period from the accounting database 202. In 838, the system determines whether the accounting period and state are such that a resource call may be issued. To issue a resource call with commitment vintages, an appropriate unit NAV must be available to calculate and issue the additional units resulting from the resource call. An appropriate unit NAV is available if the current accounting period is the same as the current operating period (e.g., both the current calendar month), a NAV is available for the start of the current accounting period and the accounting period state is either “processing subscriptions” or “open”. If these conditions do not exist, in S839 the system records the period and state data used S838 in a temporary database for offline analysis and processing terminates in S898. Otherwise, in S840, the system retrieves the unit NAV for the vehicle corresponding to the start of the accounting period, from the accounting database 202. S841 through S850 will generally be performed for each existing commitment vintage. In S841, to enforce the standardized scaling, the system calculates a unit resource call amount for the commitment vintage being processed where

CV Unit Resource Call Amount=(DV Resource Call Amount/No. of CV Units)×(CV UHC/DV UHC) (24)

and where the amount of resource to be called by the vehicle is as calculated in S812, the drawdown vehicle UHC, the period applicable UHC and number of units of the commitment vintage being processed are as found in the accounting database 202. In some implementations, the commitment vintage unit resource call amount and vehicle resource call amount may be adjusted to reflect at least a minimum commitment vintage unit resource call amount. In S842, the system determines whether the commitment vintage unit resource call amount is greater than the commitment vintage unit UHC. If so, in S844 the system records the data calculated in S806, S810, S812 and S841 in a temporary database for off-line analysis, data recorded in the accounting database 202 in S850 is erased and the process terminates in S898. (Off-line analysis may indicate that the commitment vintage unit resource call amount must be reduced via the modification of impactful calculation parameters, and the resource call processing be repeated after data impacted by the terminated execution has been appropriately reset.) Otherwise the process continues in S846. In S846, the system prepares a resource call for each holder that, per the holder database 204, has units associated with the commitment vintage being processed. The resource call is prepared by calculating both an amount of resource to call from each holder and the number of additional units associated with the commitment vintage being processed that will be issued to that holder where for each holder i

Resource Call Amtᵢ=CV Unit Resource Call Amount×No. of CV Unitsᵢ (25)

and

Additional CV Unitsᵢ=Resource Call Amtᵢ/Unit NAV (26)

In S848, to enforce the standardized scaling, using the number of commitment vintage units used in S841, the system calculates a revised commitment vintage UHC, a revised number of commitment vintage units and a revised commitment vintage unit UHC

Revised CV UHC=CV UHC−CV Unit Resource Call Amount×No. of CV Units (27)

Revised No. of CV Units=No. of CV Units+sum of Additional CV Unitsᵢ (28)

Revised CV Unit UHC=Revised CV UHC/Revised No. of CV Units (29)

In S850, the system records in the accounting database 202, for the commitment vintage being processed, the revised commitment vintage UHC, revised number of commitment vintage units and revised commitment vintage unit UHC, effective the date of the call issuance. In S852, the system determines whether there is another existing commitment vintage remaining to be processed. If so, processing continues with another existing commitment vintage beginning in S841. Otherwise, processing continues in S854. In S854, the system calculates and records in the accounting database 202 a revised UHC for the drawdown vehicle, effective the date of call issuance, where the revised drawdown vehicle UHC is the sum of each existing commitment vintage UHC. In S855, using the data collectively prepared in the iterations of S846, the system issues the resource call to holders. For each holder, the call includes identification of the vehicle and commitment vintage, the holder's number of commitment vintage units prior to the call, the commitment vintage unit resource call amount, and optionally the holder's resource call amount, the unit NAV, the effective date of the additional units issued (which in some implementations may be have financial impact from the start of the accounting period), and the holder's number of additional units issued, depending on the notification method and destination. When commitment vintages are in use, a holder will receive a resource call for each commitment vintage in which they have associated units. In such circumstances, in the interests of clarity, conciseness and efficiency, the system may group notifications of multiple resource calls to a single holder, each pertaining to a different commitment vintage, into a single communication. The call notifications may be distributed by the notification components of the system via subscribing participant systems 30 or in the form of a text message, push notification, email, etc., with an embedded link leading to stored specified parameters of the calls. In S856, the system records the details of the resource calls issued in S854. Holder specific detail, including the number of additional units issued per holder, the association of those units to a commitment vintage, and the amount receivable from each holder is recorded in the holder database 204. The total amounts receivable by commitment vintage for resource calls is recorded in the accounting database 202. In S860, the system notifies the transfer agency system 60 of the resource call details, including identifying holder information, the number of additional units issued to each holder, their effective date of issuance, the associated unit NAV and optionally the amount receivable from each holder. In some implementations, the operational staff will subsequently complete the resource calls in satisfaction of the receivables via transfer agency system 60 related systems which may include blockchain based smart contracts which transfer cash equivalent holdings from the blockchain digital wallets of holders to a digital wallet of the drawdown vehicle. The system also notifies the vehicle administration system 50 of the total amounts receivable by the vehicle and, optionally, the total of new units issued by the vehicle. The process then terminates in S898.

FIG. 9 is a flow chart illustrating the holder receivable tracking process performed by the holder receivable tracker 255 of the system in accordance with implementations of the system. The process begins in S900. In S906, the system attempts to match unsatisfied holder receivables for the vehicle being administered recorded in the holder database 204 with holder cash receipt records provided by other sources/systems. In some implementations, the transfer agent system 60 may provide such records. In some implementations, other sources of administration data may be employed. In S910, the system determines whether there are unsatisfied holder receivables. If not, the process continues in S942. If there are unsatisfied receivables, in S916 the system identifies whether any of the unsatisfied receivables have been designated to have an associated subscription or resource call notice re-issued. If so, in S920 the system re-issues all such notices and records in the holder database 204 that the notices have been re-issued. These re-issued notices may be distributed by the notification components of the system via subscribing participant systems 30 or in the form of a text message, push notification, email, etc., with an embedded link leading to stored specified parameters of the receivable. In S926, the system identifies whether any of the unsatisfied receivables have been designated as being in default. If not, the process continues in S942. If unsatisfied receivables have been designated as being in default, in S930 the system identifies units to be forfeit. In some implementations, the quantity of units forfeited will be of a value equal to the receivable amount in default. In other implementations, the quantity of units forfeited will correspond to the defaulted receivable plus some of amount of vehicle expenses incurred due to the default. In other implementations, the number of units on which the defaulted receivable was based will be forfeited. In S932 the system determines whether commitment vintages are in use. If not, in S934 the system executes a unit forfeit process for the identified units. This unit forfeit process includes: revising the associated receivable records in the holder database to reflect that the receivable resulted in the forfeit; notifying the transfer agent system 60 of the units forfeited with associated holder identifying information; notifying impacted holders of the unit forfeiture (such notices may be distributed by the notification components of the system); and notifying the vehicle accounting system 50 of the reduction in receivable amounts and, optionally, the reduction in vehicle units. In S936 to enforce the standardized scaling, using the drawdown vehicle UHC and drawdown vehicle unit UHC from the accounting database 202 associated with the period of forfeiture, the system calculates and records in the accounting database a revised drawdown vehicle UHC where

Revised DV UHC=DV UHC−DV Unit UHC×No. of Forfeited Units (30)

Processing then continues in S942. If in S932 the systems determines that commitment vintages are in use, in S938 the system executes a unit forfeit process. The process is similar to the process of S934 and includes the additional step of assigning forfeited units to commitment vintages. The system assigns the units forfeited on a pro rata basis to one or more existing commitment vintages in which the forfeiting holder has associated units, according to the number of the holder's units associated with each commitment vintage. The effect of this assignment is a pro rata reduction in each forfeiting holder's uncontributed commitment by commitment vintage. In S939 to enforce the standardized scaling, for each commitment vintage associated with forfeited units, using that commitment vintage number of units and commitment vintage unit UHC associated with the period of forfeiture from the accounting database 202 the system calculates and records in the accounting database a revised commitment vintage number of units and a revised commitment vintage UHC where

Revised CV No. of Units=CV No. of Units−Forfeited Units Assigned to the CV (31)

Revised CV UHC=Revised CV No. of Units×CV unit UHC (32)

In S940, the system calculates and records in the accounting database a revised drawdown vehicle UHC where

Revised DV UHC=sum of each existing CV UHC (33)

In S942, the system invokes the reporting engine 264 to generate a holder receivable reconciliation report, which in addition to identifying unsatisfied holder receivables, may identify the re-issued notifications and unit forfeitures associated with unsatisfied holder receivables. The process terminates in S950.

FIG. 10 is a flow chart illustrating the resource return process performed by the resource return engine 256 of the system in accordance with implementations of the system. This resource return process enforces and maintains the relationship between a holder's number of units and their UHC, as reflected by the drawdown vehicle's unit UHC or a commitment vintage unit UHC. This process also creates the relationship between a holder's number of units and their resource return amount, as reflected by a unit resource return amount. These relationships enable the system to provide efficiencies over current systems. The process begins in S1000. In S1006 according to a setting stored in the accounting database 202 and maintained via the database editor 260, the system determines whether the vehicle being administered may recall the resource being returned. When a vehicle is being wound down in advance of an expected dissolution, or in the later stages of a finite life vehicle, the indicator may be set such that resource may not be recalled subsequently. If resource may be recalled, in S1010 the system calculates an expected cash availability for the vehicle in the near term (in some implementations such period may be specified in the accounting database 202 and maintained via the database editor 260), assuming that resource returned may be subsequently recalled in the long term. Otherwise, in S1016 the system calculates an expected cash availability for the vehicle in the long term (in some implementations such period may be specified in the accounting database 202 and maintained via the database editor 260), assuming that resource returned may not be subsequently recalled. In both S1010 and S1016, various implementations may use different algorithms for this calculation. Variables used in these algorithms may include the vehicle's current cash balance, payables, receivables, debt, value of liquid and illiquid portfolio holdings, realized gains and income to be distributed, whether and with what frequency the distribution policy of the vehicle requires realized gains and income to be distributed and the UPC recorded in the accounting database 202. Additional variables may include a factor to reflect the percentage of illiquid portfolio holdings that may be harvested (net of expected illiquid portfolio investments), a factor to reflect the percentage of UPC which may be called, planned unit repurchases and an estimate of vehicle fees and expenses that may be incurred. In S1010, these additional variables may be considered over the near term. In S1016, these additional variables may be considered over the long term, which may extend through the expected life of the vehicle.

In S1020, to identify an expected excess, the system compares the expected cash availability to a maximum desired cash threshold, which in some implementations may be stored in the accounting database 202 and maintained via the database editor 260. If the expected cash availability is greater than the threshold, an excess is expected. If not, an excess is not expected, and the process ends in S1098. Otherwise, in S1026 the system determines the amount of resource to be returned by the vehicle. Various implementations may use different algorithms for this calculation. Variables used in these algorithms may include the expected excess identified in S1020 and a minimum vehicle resource return amount. In S1030 to enforce the standardized scaling, the system calculates a unit resource return amount where

Unit Resource Return Amount=DV Resource Return Amount/No. of DV Units (34)

and where the amount of resource to be returned by the vehicle is as calculated in S1026, and the number of drawdown vehicle units for the applicable period is as found in the accounting database 202. In some implementations, the unit resource return amount and vehicle resource return amount may be adjusted to reflect at least a minimum unit amount. In S1036, the system determines an amount of resource to return to each holder from the holder's number of units as contained in the holder database where for each holder where for each holder i

Resource Return Amtᵢ=Unit Resource Return Amount×No. of Unitsᵢ (35)

In S1046, the system determines whether the resource being returned is subject to a subsequent re-call. If not, the unit recallable amount is zero and the process continues in S1066. Otherwise, in S1048 the system determines the unit recallable amount, i.e., portion of the unit resource return amount calculated in S1026 subject to recall. In some implementations, such portion may be variable, specified in the accounting database 202 and maintained via the database editor 260. The unit recallable amount is less than or equal to the unit resource return amount by definition. In S1050 the system determines whether commitment vintages are in use. If not, in S1052 to enforce the standardized scaling, using the drawdown vehicle unit UHC for the applicable period from the accounting database 202, the drawdown vehicle unit UHC and drawdown vehicle UHC are calculated where

Revised DV Unit UHC=DV Unit UHC+unit recallable amount (36)

Revised DV UHC=Revised DV Unit UHC×No. of Vehicle Units (37)

In S1054, the system records the drawdown vehicle UHC and drawdown vehicle unit UHC, effective the date of return issuance, in the accounting database 202 and processing continues in S1066.

If in S1050 the system determines that commitment vintages are in use, processing continues in S1056. S1056 through S1058 will be performed for each existing commitment vintage. In S1056 to enforce the standardized scaling, using the recallable amount calculated in S1048 and the commitment vintage number of units for the applicable period from the accounting database 202, the system calculates the commitment vintage unit UHC and commitment vintage UHC for the commitment vintage being processed where

Revised CV Unit UHC=CV Unit UHC+unit recallable amount (38)

Revised CV UHC=Revised CV Unit UHC×CV No. of Units (39)

In S1058 the system records the commitment vintage UHC and commitment vintage unit UHC, effective the date of return issuance, in the accounting database. In S1060, the system determines whether there is another existing commitment vintage remaining to be processed. If so, processing continues with another existing commitment vintage beginning in S1056. Otherwise, processing continues in S1062. In S1062, the system calculates the drawdown vehicle UHC where

Revised DV UHC=sum of every existing CV UHC (40)

In S1064, the system records the revised drawdown vehicle UHC, effective the date of return issuance, in the accounting database 202.

In S1066, the system issues the resource return notifications to holders. The return notification includes identification of holder's number of units, and optionally the unit resource return amount, the holder's resource return amount, the unit recallable amount if any and the revised (drawdown vehicle or commitment vintage) unit UHC(s) applicable to each holder, depending on the notification method and destination. Note that if commitment vintages are in use, a holder may have units associated with multiple commitment vintages and therefore have multiple revised commitment vintage unit UHCs. The notifications may be distributed by the notification components of the system via subscribing participant systems 30 or in the form of a text message, push notification, email, etc., with an embedded link leading to stored specified parameters of the returns. In S1068, the system records the details of the resource return notifications issued in S1066, including the amount payable to each holder. In S1070, the system notifies the transfer agency system 60 of the resource return details, including the unit resource return amount, and optionally each holder's number of units, their identifying holder information and the resource return amount payable to each holder. In some implementations, the system also notifies the vehicle administration system 50 of the total amount payable by the vehicle. The operational staff will subsequently complete the resource returns in satisfaction of the payables, in some implementations via the transfer agency system 60 and related systems. In some implementations, related systems may include blockchain based smart contracts which distribute cash equivalent holdings of the vehicles to blockchain digital wallets of holders. Note that, as with meeting any vehicle payable, executing the resource return may require operational staff to liquidate assets so that the vehicle has enough cash or cash equivalents to meet its obligation. The process terminates in S1098.

The redemption engine 258 consists of two processes: an initial redemption validation process and a redemption execution process. In those implementations where the illiquid drawdown vehicle is registered under the Investment Company Act of 1940, holders redeem their units through a tender offer and repurchase process. In that case, a holder's response to a tender offer is the functional equivalent of a redemption request and will be processed by the redemption engine in a comparable manner. Redemption requests may be submitted with the redemption amount specified via a number of vehicles units, as a percentage of the redeeming holders units or, in some implementations, in terms of the value of the units requested to be redeemed (or repurchased).

The initial redemption validation process is executed in response to receipt of a redemption request (or response to a unit repurchase tender offer) and ends with the request being rejected or being recorded for execution at an appropriate time. FIG. 11 is a flow chart illustrating a process for redemptions in accordance with an implementation of the system. The process begins in S1100. In S1106, the system receives a redemption request to the vehicle being administered (or in some implementations a response to a unit repurchase tender offer). In S1110, the system performs initial validations on the request. These validations may include validation of the holder's identifying information and, if the request is to redeem a specified amount of vehicle units, that the holder has at least that many units as recorded in the holder database 204. In some implementations, early redemption penalties may be assessed, and redemption requests may be submitted in such manner to avoid such penalties, e.g., to redeem only units not subject to an early redemption penalty. S1110 may incorporate such considerations in its validations. Additional validations, such as those predicated on the vehicle's unit NAV, may be needed after the unit NAV for the period has been finalized and performed during the execution of redemptions. In S1116, the system determines whether the redemption request is valid. If the request is not valid, in S1120 the system issues a rejection notification, specifying the reason for rejection. The holder notification may be distributed by the notification components of the system via subscribing participant systems 30 or in the form of a text message, push notification, email, etc., with an embedded link leading to redemption details and reason for rejection. Otherwise in S1126, the system records the validated redemption request as a pending redemption request queued for subsequent execution in the holder database 204. The process completes in S1198.

FIG. 12, FIG. 12A, FIG. 12B and FIG. 12C are flow charts illustrating a redemption execution process in accordance with an implementation of the system. When applied to an illiquid drawdown vehicle, this redemption process enforces and maintains the relationship between a holder's number of units and their UHC, as reflected by the drawdown vehicle's unit UHC or a commitment vintage UHC. This relationship among others enables the system to provide efficiencies over current systems. The process begins on FIG. 12 in S1200. In S1202, the system retrieves the current accounting period and state of that period from the accounting database 202. Successfully executed redemptions will have an effective date of the end of the accounting period. In S1204, the system determines whether the state of the current accounting period is “executing redemptions”. If not, the process ends in S1299. Otherwise, the process continues in S1210 (FIG. 12A) where the system calculates the current cash available for repurchases by the vehicle. Various implementations may use different algorithms for this calculation. Variables used in these algorithms may include the minimum desired cash threshold, which in some implementations may be stored in the accounting database 202 and maintained via the database editor 260, the vehicle's current cash balance, payables, receivables, debt, value of liquid portfolio holdings, realized gains and income to be distributed, whether and with what frequency the distribution policy of the vehicle requires realized gains and income to be distributed. Some implementations may set the cash available to a portion of the drawdown fund's NAV, where that portion is as specified in the accounting database 202 and maintained via the database editor 260. In S1212 the system determines whether the cash available for vehicle unit repurchases is greater than the minimum repurchase amount, which in some implementations may be stored in the accounting database 202 and maintained via the database editor 260. If not, the process terminates in S1299. Otherwise in S1214, using the appropriate period UHC and UPC for the vehicle being administered from the accounting database 202, the system calculates the excess UHC for the vehicle where

Excess UHC=UHC−UPC*UPC Scaling Factor (41)

and where the UPC scaling factor, intended to be a positive number less than or equal to one, may be stored in the accounting database 202 and maintained via the database editor 260. The UPC scaling factor incorporates the vehicle's expectation that less than the full commitment made by the vehicle will be called by its underlying portfolio. In S1216, the system determines whether the excess UHC is greater than or equal to zero. If not, the process terminates in S1299. Otherwise in S1218 the system calculates a maximum number of units it has adequate cash to repurchase, using the ending Unit NAV of the accounting period for which redemptions are being processed for the vehicle being administered as retrieved from the accounting database 202 where

Max No. of Units Cash Repurchase=Cash Available for Repurchases/Unit NAV (15)

In S1220, the system determines whether there are unprocessed pending redemptions for the accounting period as retrieved in S1202. If not, the process continues in S1240. If the system determines in S1220 that there are unprocessed pending redemptions, in S1222 the system retrieves the next unprocessed pending redemption request with an effective date as of the end of the accounting period. In S1224, the system performs validations on and adjustments to the redemption request. Validations may include verifying that, for holders requesting a redemption of a specific value, the vehicle units associated with that holder have at least the value of the requested redemption. Other validations may include whether, if the redeeming holder is projected to have units remaining after the redemption is executed, the value of those remaining vehicle units is at least the vehicle's minimum investment amount. Adjustments may vary across different implementations of the system. As a minimum, requests which specify a redemption value or percentage of a redeeming holder's units will be amended to reflect a number of drawdown vehicle units, consistent with the unit NAV. In some implementations, adjustments may include reducing the size of the redemption request (so that the redemption may be satisfied within the value of the redeeming holder's vehicle units) and annotating a potential increase to the size of the redemption request to include all of an investor's shares (to repurchase all vehicle units of an investor who would otherwise hold less than the minimum investment value following their requested redemption). In S1226, the system determines whether the redemption request is valid for continued execution. If not, in S1228 the system queues a rejection notice for the redemption request and continues processing in S1220. The notice may include the specified parameters of the redemption and cause of its rejection.

If in S1226 the system determines that the redemption request is valid for continued execution, processing will continue in S1232. In S1232 the redemption request as amended is recorded in the holder database 204. In S1238, the system determines whether commitment vintages are in use. If not processing continues in S1220. Otherwise, in S1239 the system assigns the units requested for redemption on a pro rata basis to one or more existing commitment vintages in which the holder has associated units, or if early redemption penalties may be assessed and the redemption requested that units subject to an early redemption penalty be excluded, the system assigns the units being redeemed only to commitment vintages not subject to an early redemption penalty, in either case according to the number of the holder's units associated with each commitment vintage. The system also associates these assignments with the amended redemption request and records the assignments in the holder database 204. When redemption processing is complete, excluding any units subject to an early redemption penalty if such exclusion was requested, the effect of this assignment may be a pro rata reduction in each holder's uncontributed commitment by commitment vintage. The process continues in S1220, to check for additional unprocessed pending redemptions for the current period.

In S1240, after all pending redemptions for the current period have been examined and rejected or adjusted as necessary, the system determines whether there are any valid redemption requests for continued execution. If not, the process terminates in S1299. Otherwise, the process continues in S1250 (FIG. 12B).

In S1250, the system reviews the validated and amended redemption requests recorded in S1232 and calculates the aggregate number of drawdown vehicle units requested for redemption. In S1252, the system determines whether commitment vintages are in use. If not, in S1254, using the period appropriate unit UHC of the vehicle being administered as retrieved from the accounting database 202 the system calculates the UHC of the number of drawdown vehicle units requested for redemption, where

UHC of redemptions requested=No. of DV units requested for redemption×DV unit UHC (16)

Processing continues in S1260. If in S1252, the system determined that commitment vintages were in use, then in S1256 the system reviews each commitment vintage to which units requested for redemption were assigned and, using the period appropriate CV unit UHC retrieved from the accounting database 202, calculates the commitment vintage UHC of the commitment vintage units assigned for redemption, where

CV UHC of redemption units assigned=No. of CV units assigned for redemption×CV unit UHC (17)

In S1258 the system calculates the UHC of redemptions requested as the sum of each of the commitment vintage UHC values calculated in S1256.

In S1260, the system calculates the commitment required to satisfy the redemptions requested where

Commitment Required=No. of DV units requested for redemption×unit NAV+UHC of redemptions requested (18)

In S1262, the system calculates the commitment available to satisfy the redemptions requested where

Commitment Available=Current Cash Avail. For Repurchases+Excess UHC (19)

In S1264, the system determines whether the number of units requested for redemption are less than or equal to the maximum number of units which could be repurchased in cash, as determined in S1218. If so, processing continues in S1270. Otherwise in S1266, the system calculates a redemption scaling factor and an adjusted UHC of redemptions requested where

Redemption Scaling Factor=Max No. of Units Cash Repurchase/No. of DV units requested for redemption (20)

Adjusted UHC of Redemptions Requested=UHC of Redemptions Requested×Redemption Scaling Factor (21)

In S1268, the system determines whether the adjusted UHC of redemptions requested is less than or equal to the excess UHC calculated in S1214. If so, processing continues in S1278 (FIG. 12C). Otherwise, processing continues in S1272.

If in S1264 the system determined that the number of units requested for redemption are less than or equal to the maximum number of units which could be repurchased in cash, in S1270 the system determines whether the commitment required is less than or equal to the commitment available. If so, in S1276, the redemption scaling factor is set to one, meaning no scaling is required. Otherwise in S1272, the system calculates a redemption scaling factor where

Redemption Scaling Factor=Commitment Available/Commitment Required (22)

In either case, processing continues in S1278 (FIG. 12C).

In S1278, the system tests whether the redemption scale factor is less than one. If not processing continues in S1282. Otherwise, in S1279 the system further amends and subsequently re-records each of the validated redemption requests recorded in S1232. The number of units specified in each redemption request is amended where

Amended No. of Units=No. of Units×Redemption Scaling Factor (23)

In S1280, the system determines whether commitment vintages are in use. If so, in S1281 the system amends each assignment of units to commitment vintages made in S1239 according to the formula above and records the amended assignment. In S1282, the system calculates and assesses any applicable redemption penalties. Both the identification of units subject to redemption penalties and the calculation of penalty amounts themselves may be implementation specific. Identification may be based on the length of the time between the effective date of the unit repurchase and the date the redeeming holder acquired the units being redeemed, which may be determined using information recorded in the holder database 204 and using the assignment of requested redemption units to commitment vintages performed in S1239 and S1281. The penalty amounts themselves may be calculated based on the value of units being redeemed, the uncontributed commitment of units being redeemed, a combination of both measures, or some other metric. Assessed penalties are reflected and re-recorded in amended redemption requests and, if applicable, in the commitment vintage assignments recorded in S1239 and S1281. In S1283 the system determines whether the redemption scaling factor equals one, i.e., no scaling was applied to the redemptions requested. If not, processing continues in S1286. Otherwise, in S1284 the system calculates both the remaining cash and remaining commitment available to repurchase additional units according to the amended redemption requests and the drawdown vehicle unit UHC or commitment vintage unit UHCs and assignment of redemption units to commitment vintages as applicable, where

$$Remaining Cash = Cash Available for Repurchases - aggregate number of units being redeemed \times unit NAV + aggregate redemption penalties assessed \qquad ( 24 )$$

$$Remaining Commitment = Remaining Cash + Excess UHC - aggregate UHC of units being redeemed \qquad ( 25 )$$

and where the UHC of each unit being redeemed is either the drawdown vehicle unit UHC or, if commitment vintages are in use, the commitment vintage unit UHC of the commitment vintage to which the unit being redeemed is associated. In S1285, the system identifies additional units for repurchase. Identification of such units may begin by identifying holders if any that, after the amended redemption requests are completed will have fewer than a minimum number of units or a minimum value of remaining units, as may have been annotated in S1227. Next, such holders and their remaining units may be ordered by size. Then the system may review the ordered list of holders and their units to identify a set of holders and their units for which a) the aggregate value of the set of units, i.e., the aggregate number of units multiplied by the unit NAV, is less than or equal to the remaining cash, and b) the aggregate commitment of the set units, i.e., the aggregate value of the set of units+the aggregate UHC of the set of units is less than or equal to the remaining commitment, where the UHC of each unit in the set is either the drawdown vehicle unit UHC or, if commitment vintages are in use, the commitment vintage unit UHC of the commitment vintage to which the unit in the set is associated. If such a set is identified, amended redemption requests and, if applicable, assignments of units being redeemed to commitment vintages are revised and re-recorded as appropriate to reflect the additional set of units to be repurchased. Processing continues in S1286.

In S1286, the system determines whether a dry run is being executed. If not processing continues in S1291. Otherwise, in S1287, the system records the results in temporary storage for subsequent analysis. The results recorded may include: (i) proposed redemption transactions as reflected in the amended redemption requests; (ii) if applicable, the assignment of redeeming units by redeeming holder to commitment vintages; (iii) cash available for repurchases; (iv) excess UHC; (v) the maximum number of units that may be cash repurchased, as calculated in S1218; (vi) the number of units requested for redemption, as calculated in S1250 and the UHC of redemptions requested as calculated in S1254 or S1258; (vii) the commitment required and commitment available as calculated in S1260 and S1262 respectively; and (viii) the redemption scaling factor. In S1288, the redemption requests as they were prior to redemption process are restored to their pre-execution queue and the rejection notices queued in S1228, the amended redemption requests and, if applicable, the assignment of redeeming units to commitment vintages are erased. After S1288, the process is terminated in S1299. If in S1286, the system determines that this is not a dry run, the amended redemption requests and, if applicable, commitment vintage assignments as recorded are considered final and the process continues in S1289.

In S1289, using the amended redemption requests, the system calculates and records in the holder database 204, with an effective date of the end of the accounting period, the amount payable to each redeeming holder where for each redeeming holder i

Amount Payableᵢ=Units Redeemedᵢ×Unit NAV−Penalty Assessedᵢ (53)

In S1291, the system determines whether commitment vintages are in use. If so, in S1292 to enforce the standardized scaling for each commitment vintage to which redeeming units were assigned, using the applicable commitment vintage number of units from the accounting database 202 and the commitment vintage assignments made, the system calculates and records, with an effective date of the end of the accounting period, a revised commitment vintage number of units and revised commitment vintage UHC in the accounting database 102 where:

Revised CV No. of Units=CV No. of Units−redeeming Units assigned to the CV (54)

and

Revised CV UHC=Revised CV No. of Units×CV Unit UHC (55)

Additionally, the system calculates and records a revised drawdown vehicle UHC, with an effective date of the end of the accounting period, in the accounting database 202 where:

Revised DV UHC=sum of all existing CV UHC (56)

In S1293, the system notifies redeeming holders. The notification includes the number of units repurchased as a minimum and may include the amount payable as well as all of the holder's specific redemption detail reflected in the amended redemption request and associated commitment vintage assignment. The notice may be distributed by the notification components of the system via subscribing participant systems 30 or in the form of a text message, push notification, email, etc., with an embedded link leading to stored specified parameters of the redemption as executed. Processing then continues in S1296. If in S1291 the system determines that commitment vintages are not in use, then in S1294 to enforce the standardized scaling, using the drawdown vehicle UHC and drawdown vehicle unit UHC from the accounting database 202, the system calculates and records, with an effective date of the end of the accounting period, a revised drawdown vehicle UHC in the accounting database 204 where:

Revised DV UHC=DV UHC−(DV Unit UHC×No. of Units being redeemed) (57)

In S1295 the system provides comparable notifications to holders as the system does in S1293, without incorporating any commitment vintage related information. Processing then continues in S1296.

In S1296, the rejection notifications queued in S1228 are issued. The notifications may be distributed by the notification components of the system via subscribing participant systems 30 or in the form of a text message, push notification, email, etc., with an embedded link leading to the stored notification details. Also, the transfer agent system 60 is notified, where such notification includes the redeeming holder's identifying information, the number of units redeemed, the effective date of the redemption and optionally the redemption proceeds. In some implementations, the vehicle accounting system 50 is also notified of the aggregate number of units redeemed, the aggregate amount payable and the effective date. In other implementations, this information may be supplied to the vehicle accounting system by the transfer agent system. In S1297, the system invokes the reporting engine to generate a redemption report, which, in some implementations, may be used by operational personnel to implement the payment of redemption proceeds. The operational staff will subsequently complete the disbursement of repurchase proceeds in satisfaction of the payables, in some implementations via the transfer agency system 60 and related systems. In some implementations, related systems may include blockchain based smart contracts which distribute cash equivalent holdings of the vehicles to blockchain digital wallets of redeeming holders. Note that, as with meeting any vehicle payable, executing the disbursement of repurchase proceeds may require operational staff to liquidate assets so that the vehicle has enough cash or cash equivalents to meet its obligation. In S1298, the system sets the state of the current accounting period to “redemptions completed”. The process ends in S1299.

FIG. 13 is a flow chart illustrating a commitment vintage merge process in accordance with an implementation of the system. The process begins in S1300. In S1302, the system identifies two commitment vintages to be merged. This identification may be accessed via a front end interface component 230, via the database editor or other means. In S1304 the system retrieves the period appropriate drawdown vehicle UHC and the UHCs and unit UHCs of the selected commitment vintages from the accounting database. In S1306 the system identifies the commitment vintage with the higher unit UHC as the commitment vintage to be eliminated. In S1308, the system calculates the impact to the UHC of the remaining commitment vintage where

Impact=No. of Units in the eliminated CV×unit UHC of the remaining CV (58)

In S1310, the system recalculates the drawdown fund UHC where

DV UHC=DV UHC−CV UHC of the eliminated CV+Impact (59)

In S1312, the system recalculates the CV UHC of the remaining CV where

CV UHC=CV UHC+Impact (60)

In S1314, effective the date of merger, the system records the recalculated DV UHC and the recalculated CV UHC of the remaining CV, and marks the eliminated CV closed in the accounting database 202. In S1316, effective the date of merger, in the holder database 204, the system updates the CV of units associated with the eliminated CV to reflect now being associated with the remaining CV. In S1318, the system determines whether a single remaining commitment vintage will be eliminated. A single remaining commitment vintage will be eliminated if there is only one commitment vintage remaining and the default operation of the vehicle being administered as reflected in the accounting database 202 is to operate without commitment vintages. If so, the process continues in S1320. Otherwise, the process terminates in S1330. If a single remaining commitment vintage is being eliminated, in S1320, effective the date of merger, the system marks the last remaining commitment vintage as closed in the accounting database 202. In S1322, effective the date of merger, the system updates units associated with the eliminated CV to reflect not being associated with any CV. The process then terminates in S1330.

In summary, the enhanced recordkeeping system described by this specification scales, as a result of a standardization approach scales dependent data items, e.g., the unit holder's uncontributed commitment, to an independent data item, i.e., the holder's number of units, reducing the amount of storage that is required for each illiquid drawdown vehicle holder. Such a system reduces the number of calculations that are required in the allocation to unit holders of illiquid drawdown vehicle gains, fees, and expense and determinations of illiquid drawdown vehicle resource calls and returns, and generally reduces the amount of computer processing that is required to administer co-mingled vehicles which utilize resource calls (i.e., drawdown vehicles), including via distributed parallel reporting using industry standard interfaces which generally reduces the need for centralized computing resources. As a result of the relationship enforced between units owned and other items reflecting a holder's vehicle interest, the enhanced recordkeeping system described herein enables more computationally efficient transfers among holders of their vehicle interests, which could be executed using digital tokens, via functionally adjacent systems implemented using blockchain technology. These improvements can be obtained by reducing data redundancy within the data recorded to reflect each illiquid drawdown vehicle holder's ownership as well as illiquid drawdown vehicle resource calls and resource returns, via use of each holder's number of units owned as the independent data item to which other data items are scaled in various collections of data as described below.

As described above, as an approach to data standardization, in some collections of data, well defined relationships, applicable to each individual data set within the collection, can be identified as existing between items within a data set. Such relationships (e.g., scaling factors) may be stored only once for the entire collection and within each data set, only the independent or reference data item need be stored. For each data set, the data items dependent on the reference data item need not be stored, but can be derived when needed, given the associated independent data item and the standardized scaling relationship applicable across the collection of data. This approach provides the benefits of (1) reducing the storage space required for each data set and therefore for the entire collection of data, (2) reducing the amount of data required to be copied or transmitted when working with multiple data sets from the collection, (3) standardizing on the use of independent reference data item(s) by the data assembling system so that each complete data set, including dependent data items can be correctly interpreted and applied by functionally adjacent heterogeneous data consuming systems and (4) facilitating distributed parallel processing and reporting of data sets, which can be conducted given the established data standardization.

As noted above, through the use and enforcement of this data standardization approach within the described enhanced recordkeeping system in which different variables are put on a common scale, in this case a number of units, both the amount of storage required and the number of calculations required are reduced. For example, the administration of illiquid private market drawdown vehicles generally requires that a holder's equity amount and their uncontributed commitment amount be stored. By scaling these values to the holder's number of units, the scaling factors which apply to every holder are stored once and only the number of units owned must be stored for each holder. This reduces the storage locations required by number of holders less three (needed to store the vehicle's units and the scaling factors). holder resource call allocation=resource call per unit×holder's number of units.

Using this approach, this standardized scaling reduces the number of computation (e.g., divisions) required by the number of holders less one (needed to calculate the allocation per unit). Additionally, these holder resource call allocations can be calculated on a distributed parallel basis by multiple systems each positioned closer to a subset of holders, reducing the need for and consumption of centralized computing resources.

The system as illustrated in the block diagrams and flowcharts of FIGS. 1-13 include one or more computer processors capable of accessing stored data and instructions to perform various steps and may operate in conjunction with software modules described herein in order to perform various functions. Many processors may be suitable and will be further described below. All of the described engines, generators, and other components may be or include software modules that are executed by the processor to perform their stated functions. Although the software modules are shown as discrete components, they may be integrated in various ways in accordance with implementations of the system.

All of the components shown in the drawing figures above may be, include, or be implemented by a computer or multiple computers. The system or portions of the system may be in the form of a “processing machine,” i.e., a tangibly embodied machine, such as a general purpose computer or a special purpose computer, for example. As used herein, the term “processing machine” is to be understood to include at least one processor that uses at least one memory. At least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example. As noted above, the processing machine used to implement the system may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the system.

The processing machine used to implement the system may utilize a suitable operating system. Thus, implementations of the system may include a processing machine running the Microsoft Windows' Vista™ operating system, the Microsoft Windows' XP™ operating system, the Microsoft Windows' NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris' operating system, the OS/2™ operating system, the BeOS™ operating system, the Macintosh operating system, the Apache operating system, an OpenStep™ operating system or another operating system or platform. It is appreciated that in order to practice the method of the system as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further implementation of the system, be performed by a single component. Further, the processing performed by one distinct component as described above may be performed by two distinct components. In a similar manner, the memory storage performed by two distinct memory portions as described above may, in accordance with a further implementation of the system, be performed by a single memory portion. Further, the memory storage performed by one distinct memory portion as described above may be performed by two memory portions.

Further, various technologies may be used to provide communication between the various processors and/or memories, as well as to allow the processors and/or the memories of the system to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the system. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the system may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various implementations of the system. Illustratively, the programming language used may include assembly language, Ada, APL, Basic, C, C++, COBOL, dBase, Forth, FORTRAN, Java, Modula-2, Pascal, Prolog, REXX, Visual Basic, and/or JavaScript, for example. Further, it is not necessary that a single type of instructions or single programming language be utilized in conjunction with the operation of the system and method of the system. Rather, any number of different programming languages may be utilized as is necessary or desirable.

Also, the instructions and/or data used in the practice of the system may utilize any compression or encryption technique or algorithm, as may be desired. An encryption module might be used to encrypt data. Further, files or other data may be decrypted using a suitable decryption module, for example.

As described above, the system may illustratively be embodied in the form of a processing machine, including a computer or computer system, for example, that includes at least one memory. It is to be appreciated that the set of instructions, i.e., the software for example that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the system may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the system.

Further, the memory or memories used in the processing machine that implements the system may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the system, a variety of “user interfaces” may be utilized to allow a user to interface with the processing machine or machines that are used to implement the system. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface may be used by the processing machine for interacting with a user either to convey information or receive information from the user. However, it should be appreciated that in accordance with some implementations of the system and method of the system, it is not necessary that a human user actually interact with a user interface used by the processing machine of the system. Rather, it is also contemplated that the user interface of the system might interact, i.e., convey and receive information, with another processing machine, rather than a human user. Accordingly, the other processing machine might be characterized as a user. Further, it is contemplated that a user interface utilized in the system and method of the system may interact partially with another processing machine or processing machines, while also interacting partially with a human user.

In addition to the embodiments described above, the following embodiments are also innovative:

Embodiment 1 is a method for an enhanced recordkeeping system for use in administering unitized private market collective investment vehicles at least one network, the method comprising:
maintaining unitized private market collective investment vehicles by storing and updating vehicle information in accounting and holder databases, including information provided by vehicle accounting and transfer agency systems;
offering subscriptions in the form of uncontributed commitments converted into units using the standardized scaled values of a current unit net asset value (NAV) and a current unit uncontributed holder commitment (UHC);
accepting and processing requests from holders to redeem from unitized private market collective investment vehicles according to both the vehicle's available cash equivalents and its excess UHC;
enabling efficient transfers among holders of their vehicle interests, executed via functionally adjacent systems using digital tokens, as a result of the standardized scaled relationship enforced between units and other items reflecting a holder's vehicle interest, such as the holder's uncontributed commitment; and
reporting private market collective investment vehicle valuations in an industry standard format at a current unit net asset value (NAV), thereby allowing intermediaries with holder specific unit quantities to calculate the value of their holder client holdings via an industry standard calculation.

Embodiment 2 is the method of embodiment 1, wherein unitized resource call amounts are calculated in a standardized scale, and resource calls generated in an amount per unit, decreasing unit UHC and UHC.

Embodiment 3 is the method of any one of embodiments 1-2, wherein unitized resource return amounts are calculated in the standardized scale of an amount per unit and make a specific portion, which could be none or all, of the amount subject to a subsequent resource call, increasing unit UHC and UHC according to the amount subject to recall.

Embodiment 4 is the method of any one of embodiments 1-3, further comprising calculating a Diversification Minimum Basis and producing a Diversification Report, according to the assets in the unitized private market collective investment vehicle's portfolio.

Embodiment 5 is the method of any one of embodiments 1-4, wherein subscriptions are offered in the form of uncontributed commitments converted into units at using the standardized scaled values of a current unit net asset value (NAV) and a commitment vintage specific current unit uncontributed holder commitment (UHC), and unitized resource calls are calculated in the standardized scale, issued and processed on a commitment vintage basis.

Embodiment 6 is the method of any one of embodiments 1-5, wherein subscriptions may be processed in the manner of a subsequent closing, with similar financial terms to subscriptions processed at a vehicle's initial closing and reflecting a cost to subscribing holders' attributable to their delay, relative to subscribers in the initial close of the vehicle, in making resource contributions.

Embodiment 7 is the method of any one of embodiments 1-6, whereby two commitment vintages may be collapsed into a single commitment vintage.

Embodiment 8 is a system comprising: one or more computers and one or more storage devices storing instructions that are operable, when executed by the one or more computers, to cause the one or more computers to perform the method of any one of embodiments 1 to 7.

Embodiment 9 is a computer storage medium encoded with a computer program, the program comprising instructions that are operable, when executed by data processing apparatus, to cause the data processing apparatus to perform the method of any one of embodiments 1 to 7.

It will be readily understood by those persons skilled in the art that the present system is susceptible to broad utility and application. Many implementations and adaptations of the present system other than those herein described, as well as many variations, modifications and equivalent arrangements, will be apparent from or reasonably suggested by the present system and foregoing description thereof, without departing from the substance or scope of the system.

Accordingly, while the present system has been described here in detail in relation to its exemplary implementations, it is to be understood that this disclosure is only illustrative and exemplary of the present system and is made to provide an enabling disclosure of the system. Accordingly, the foregoing disclosure is not intended to be construed or to limit the present system or otherwise to exclude any other such implementations, adaptations, variations, modifications and equivalent arrangements.

While particular implementations of the system have been illustrated and described in detail herein, it should be understood that various changes and modifications might be made to the system without departing from the scope and intent of the system.

From the foregoing it will be seen that this system is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the disclosed system.

What is claimed is:

1. A distributed processing system comprising a plurality of computing subsystems, wherein the plurality of computing subsystems implemented by a plurality of computers in a plurality of locations, and wherein the plurality of computing subsystems comprise:
an enhanced recordkeeping subsystem,
a plurality of participant subsystems,
a vehicle accounting subsystem, and
a transfer agent subsystem,
wherein the enhanced recordkeeping subsystem is operable to execute instructions that cause the enhanced recordkeeping subsystem to perform operations comprising:
receiving, by the enhanced recordkeeping subsystem from the transfer agent subsystem, an update to quantities of units for unit holders maintained in a holder database of the enhanced recordkeeping subsystem;
receiving, by the enhanced recordkeeping subsystem from the vehicle accounting subsystem, a unit net asset value scaling factor;
providing, by the enhanced recordkeeping subsystem, to each participant subsystem of the plurality of participant subsystems, a set of scaling factors comprising the unit net asset value scaling factor and a unit uncontributed holder commitment scaling factor, and providing respective quantities of units for unit holders belonging to each participant subsystem;
computing, by each respective participant subsystem in parallel using the updated quantities of units and the unit net asset value scaling factor, updated asset values for each holder belonging to the participant subsystem;
computing, by each respective participant subsystem in parallel using the updated quantities for units and the uncontributed holder commitment scaling factor, updated uncontributed commitment values for each holder belonging to the participant subsystem; and
generating, by each participant subsystem, a respective report for each holder comprising the updated asset value and updated uncontributed commitment value derived from the holder's quantity of units.

2. The system of claim 1, wherein the increase to the quantities of units is a result of receiving a subscription request, and wherein the operations further comprise:
computing, by the enhanced recordkeeping subsystem, a quantity of units for a holder corresponding to the subscription request; and
transmitting the quantity of units to the transfer agent subsystem.

3. The system of claim 2, wherein computing the quantity of units subscribed for the holder comprises dividing a commitment amount by a sum of the scaling factors.

4. The system of claim 2, wherein computing the quantity of units comprises computing, by the enhanced recordkeeping system, the quantity of units without computing an asset value or unfunded commitment value for the holder corresponding to the subscription request.

5. The system of claim 2, wherein the operations further comprise providing, by the enhanced recordkeeping system to a first participant subsystem that provided the subscription request, the computed quantity of units without providing an asset value or uncontributed commitment value for the holder.

6. The system of claim 5, wherein the operations further comprise computing, by the first participant subsystem, an asset value and uncontributed commitment value for the holder corresponding to the subscription request using the computed quantity of units received from the enhanced recordkeeping subsystem, the unit net asset value scaling factor, and the unit UHC scaling factor.

7. The system of claim 1, wherein generating a respective report by each participant subsystem comprises generating reports by the plurality of participant subsystems at least partially in parallel.

8. The system of claim 1, wherein the update to the quantities of units is a result of a resource return event, and wherein the operations further comprise:
computing, by the enhanced recordkeeping subsystem, an updated uncontributed holder commitment scaling factor.

9. The system of claim 8, wherein computing the updated uncontributed holder commitment scaling factor comprises computing, by the enhanced recordkeeping subsystem, the uncontributed holder commitment scaling factor without computing updated uncontributed holder commitment values required for the reports.

10. The system of claim 9, wherein the operations further comprise:
providing, by the enhanced recordkeeping subsystem, the updated uncontributed holder commitment scaling factor to each of the participant subsystems; and
computing, by the participant subsystems at least partially in parallel, updated uncontributed commitment values from the updated uncontributed holder commitment scaling factor and respective quantities of units for each holder.

11. The system of claim 1, wherein the update to the quantities of units is a result of a resource call event, and wherein the operations further comprise:
computing, by the enhanced recordkeeping subsystem, a respective additional quantity of units for each holder; and
computing, by the enhanced recordkeeping subsystem, an updated uncontributed holder commitment scaling factor.

12. The system of claim 11, wherein the operations further comprise:
providing, by the enhanced recordkeeping subsystem, the respected additional quantity of units to the plurality of participant subsystems and providing the updated uncontributed holder commitment scaling factor; and
computing, by the plurality of participant subsystems at least partially in parallel, updated asset values and updated uncontributed commitment values from the received updated quantity of units, the unit net asset scaling factor, and the updated uncontributed holder commitment scaling factor.

13. The system of claim 1, wherein the decrease to the quantities of units is a result of receiving a redemption request, and wherein the operations further comprise:
computing, by the enhanced recordkeeping subsystem, a quantity of units for a holder corresponding to the redemption request; and
transmitting the quantity of units to the transfer agent subsystem.

14. The system of claim 13, wherein the operations further comprise providing, by the enhanced recordkeeping system to a first participant subsystem that provided the redemption request, the computed quantity of units.

15. The system of claim 14, wherein the operations further comprise computing, by the first participant subsystem, an asset value and uncontributed commitment value for the holder corresponding to the redemption request using the computed quantity of units received from the enhanced recordkeeping subsystem, the unit net asset value scaling factor, and the unit UHC scaling factor.

16. A method performed by a distributed processing system comprising a plurality of computing subsystems, wherein the plurality of computing subsystems are implemented by a plurality of computers in a plurality of locations, and wherein the plurality of computing subsystems comprise:
an enhanced recordkeeping subsystem,
a plurality of participant subsystems,
a vehicle accounting subsystem, and
a transfer agent subsystem,
wherein the method comprises:
receiving, by the enhanced recordkeeping subsystem from the transfer agent subsystem, an update to quantities of units for unit holders maintained in a holder database of the enhanced recordkeeping subsystem;
receiving, by the enhanced recordkeeping subsystem from the vehicle accounting subsystem, a unit net asset value scaling factor;
providing, by the enhanced recordkeeping subsystem, to each participant subsystem of the plurality of participant subsystems, a set of scaling factors comprising the unit net asset value scaling factor and a unit uncontributed holder commitment scaling factor, and providing respective quantities of units for unit holders belonging to each participant subsystem;
computing, by each respective participant subsystem in parallel using the updated quantities of units and the unit net asset value scaling factor, updated asset values for each holder belonging to the participant subsystem;
computing, by each respective participant subsystem in parallel using the updated quantities for units and the uncontributed holder commitment scaling factor, updated uncontributed commitment values for each holder belonging to the participant subsystem; and
generating, by each participant subsystem, a respective report for each holder comprising the updated asset value and updated uncontributed commitment value derived from the holder's quantity of units.

17. The method of claim 16, wherein the increase to the quantities of units is a result of receiving a subscription request, and wherein the operations further comprise:
computing, by the enhanced recordkeeping subsystem, a quantity of units for a holder corresponding to the subscription request; and
transmitting the quantity of units to the transfer agent subsystem.

18. The method of claim 17, wherein computing the quantity of units subscribed for the holder comprises dividing a commitment amount by a sum of the scaling factors.

19. The method of claim 17, wherein computing the quantity of units comprises computing, by the enhanced recordkeeping system, the quantity of units without computing an asset value or unfunded commitment value for the holder corresponding to the subscription request.

20. One or more non-transitory computer storage media encoded with computer program instructions that when executed by a distributed processing system comprising a plurality of computing subsystems, cause the distributed processing system to implement a plurality of computing subsystems comprising:
an enhanced recordkeeping subsystem,
a plurality of participant subsystems,
a vehicle accounting subsystem, and
a transfer agent subsystem,
and wherein the distributed processing system is configured perform operations comprising:
receiving, by the enhanced recordkeeping subsystem from the transfer agent subsystem, an update to quantities of units for unit holders maintained in a holder database of the enhanced recordkeeping subsystem;
receiving, by the enhanced recordkeeping subsystem from the vehicle accounting subsystem, a unit net asset value scaling factor;
providing, by the enhanced recordkeeping subsystem, to each participant subsystem of the plurality of participant subsystems, a set of scaling factors comprising the unit net asset value scaling factor and a unit uncontributed holder commitment scaling factor, and providing respective quantities of units for unit holders belonging to each participant subsystem;
computing, by each respective participant subsystem in parallel using the updated quantities of units and the unit net asset value scaling factor, updated asset values for each holder belonging to the participant subsystem;
computing, by each respective participant subsystem in parallel using the updated quantities for units and the uncontributed holder commitment scaling factor, updated uncontributed commitment values for each holder belonging to the participant subsystem; and
generating, by each participant subsystem, a respective report for each holder comprising the updated asset value and updated uncontributed commitment value derived from the holder's quantity of units.
